(19) United States
(12) Patent Application Publication
(10) Pub. No.: US 2007/0216703 A1
(43) Pub. Date: Sep. 20, 2007

(54) IMAGE DISPLAY APPARATUS

(76) Inventors: Takashi Ohkuma, Kanagawa (JP); Hitoshi Hattori, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/683,779

(22) Filed: Mar. 8, 2007

(30) Foreign Application Priority Data
Mar. 17, 2006 (JP) 2006-075349

(51) Int. Cl. G09G 5/00

(52) U.S. Cl. 345/588

(57) ABSTRACT

A rotating unit forwards and rewinds a recording medium by rotating in a normal direction and in a reverse direction, respectively. A recording unit records an image on a surface of the recording medium. An erasing unit erases the image recorded on the surface of the recording medium. A shift-amount adjusting unit adjusts a shift amount per unit time of a forwarding portion of the recording medium at a recording position or on an upstream side of the recording position in a forwarding direction. A weight is fixed to the forwarding portion of the recording medium exposed outside from an opening that is provided on a casing.

### CROSS-REFERENCE TO RELATED APPLICATIONS

The present document incorporates by reference the entire contents of Japanese priority document, 2006-075349 filed in Japan on Mar. 17, 2006

### BACKGROUND OF THE INVENTION

1. Field of the Invention

The present invention relates to an image display apparatus that displays an image on a recording medium by repeating recording and erasing of an image.

2. Description of the Related Art

In recent years, the growth of paper consumption due to the popularization of personal computers and printers has been a hindrance to global environment conservation activities, such as energy saving and reduction of CO₂ emissions. Accordingly, a type of image display apparatus that uses a rewritable recording medium on which an image can be recorded and erased repetitively (hereinafter, simply “recording medium”) as an alternative to paper has been attracting attention. The recording medium can repeat recording and erasing of images easily and quickly.

For example, Japanese Patent Application Laid-open No. 2004-148536 discloses the above type of image display apparatus. In this image display apparatus, a reversible thermosensitive recording medium is laid across in a tensioned state between two paper winding shafts, while opposite ends in a lengthwise direction of a sheet-like reversible thermosensitive recording medium are wound around the paper winding shaft, respectively. This image display apparatus includes an erasing unit, a recording unit, and a transparent plate between these two paper winding shafts. The transparent plate faces a front face of the reversible thermosensitive recording medium with a predetermined gap therebetween, and serves as a screen for visually checking a partial area of an extended portion of the reversible thermosensitive recording medium from the outside of the apparatus. The reversible thermosensitive recording medium passes through the recording unit prior to approaching the opposed position with respect to the transparent plate, in the process of being fed from one of the paper winding shafts and being sequentially wound around the other paper winding shaft, and an image is recorded thereon by a write process by heating the medium. When the recorded image moves together with the reversible thermosensitive recording medium and reaches the opposed position with respect to the transparent plate, feed of the reversible thermosensitive recording medium is suspended, and the image is displayed in the suspended state. When recording and display of images are repeated, an image recording area of the recording medium is completely wound around the other winding shaft. When a winding direction of the recording medium is reversed, the image recording area moves and is rewound around one of the rollers. When the recording medium passes through an opposed position with respect to the erasing unit, the image recorded thereon is erased by a relatively low-temperature heating process.

The image display apparatus having this configuration can be used for various applications, such as a data bulletin board, a display unit of presentation materials, and a temporary output unit of an original document. However, because a screen space for displaying the image is ensured, the size of the image display apparatus increases, thereby reducing its portability.

Meanwhile, Japanese Patent Application Laid-open No. H9-216465 discloses an image display apparatus having a configuration different to that of the above image display apparatus. This image display apparatus includes a sheet-like reversible thermosensitive recording medium, with the opposite ends thereof in the lengthwise direction being wound around a winding shaft, respectively, and a recording unit and an erasing unit slidably held on the reversible thermosensitive recording medium between these winding shafts. Because there is no casing for supporting and containing these various members, it is a simple structure achieved by simply rolling a long sheet from opposite ends. Japanese Patent Application Laid-open No. H9-216465 claims that its image display apparatus is portable and capable of large screen display.

However, Japanese Patent Application Laid-open No. H9-216465 fails to disclose any specific means for making the portability of the image display apparatus having such a configuration compatible with large screen display. More specifically, to record an image normally on the reversible thermosensitive recording medium, the reversible thermosensitive recording medium must pass through the recording unit, while being fed from one of the winding shafts to the other at an equal velocity. Because such an operation cannot be made manually, a surface-movement driving unit formed of a drive motor and an equal-velocity feed mechanism is required. Further, a stretching unit for stretching the reversible thermosensitive recording medium to obtain a medium-extending area larger than a screen display size is also required. If there are no such units, images cannot be recorded, erased, or displayed. Therefore, what is described in Japanese Patent Application Laid-open No. H9-216465 is only a part of an apparatus. Furthermore, if these units are included in the image display apparatus, the stretching unit must have a large size capable of large screen display, and therefore the described image display apparatus is hardly portable. Further, if a portable and small stretching unit is included in the image display apparatus, large screen display thereof cannot be made possible.

### SUMMARY OF THE INVENTION

It is an object of the present invention to at least partially solve the problems in the conventional technology.

An image display apparatus according to one aspect of the present invention includes a recording medium on which an image can be recorded and erased repetitively; a rotating unit that is supported in a rotating manner in both a normal direction and a reverse direction, and forwards the recording medium by rotating in the normal direction or rewinds the recording medium by rotating in the reverse direction; a surface-movement driving unit that drives the rotating unit at least in the reverse direction; a recording unit that records the image on a moving surface of the recording medium; an erasing unit that erases the image recorded on the moving surface of the recording medium; a casing that accommodates the rotating unit, the surface-movement driving unit, the recording unit, and the erasing unit; a shift-amount adjusting unit that adjusts a shift amount per unit time of a forwarding portion of the recording medium in a forwarding direction at a recording position or on an upstream side of the recording position in the forwarding direction, being provided in the casing; an opening for putting in and out the forwarding portion of the recording medium after recording the image, being provided in the casing; and a weight that is fixed to the forwarding portion of the recording medium exposed outside from the opening.

An image display apparatus according to another aspect of the present invention includes a recording medium on which an image can be recorded and erased repetitively; a rotating unit that is supported in a rotating manner in both a normal direction and a reverse direction, and forwards the recording medium by rotating in the normal direction or rewinds the recording medium by rotating in the reverse direction; a surface-movement driving unit that drives the rotating unit at least in the reverse direction; a recording unit that records the image on a moving surface of the recording medium; an erasing unit that erases the image recorded on the moving surface of the recording medium; a casing that accommodates the rotating unit, the surface-movement driving unit, the recording unit, and the erasing unit; a shift-amount adjusting unit that adjusts a shift amount per unit time of a forwarding portion of the recording medium in a forwarding direction at a recording position or on an upstream side of the recording position in the forwarding direction, being provided in the casing; an opening for putting in and out the forwarding portion of the recording medium after recording the images being provided in the casing; and a fixing member for fixing the forwarding portion of the recording medium to a support that is a separate body from the casing. The fixing member is fitted to the forwarding portion of the recording medium exposed outside from the opening.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1A is a schematic of an image display apparatus according to a first embodiment of the present invention shown from the front;

FIG. 1B is a functional block diagram of the image display apparatus shown from the side;

FIG. 2 is an enlarged cross section of a reversible thermosensitive sheet of the image display apparatus;

FIG. 3 is a block diagram of the image display apparatus in a state of being fixed to a wall via a support plate;

FIG. 4 is a timing chart for explaining a recording operation and an erasing operation of the image display apparatus;

FIG. 5 is a perspective view of the image display apparatus shown from the back;

FIG. 6 is a perspective view of the support plate shown from the front;

FIG. 7 is an enlarged cross section depicting an engaged state of a hook claw with an engagement opening in the image display apparatus;

FIG. 8 is a block diagram of a casing in a state of being separated into two in the image display apparatus;

FIG. 9 is a block diagram of the casing in a state that the front side is joined with the backside;

FIG. 10A is a schematic of an apparatus according to a first modification of the image display apparatus according to the first embodiment shown from the front;

FIG. 11B is a functional block diagram of the apparatus according to the first modification shown from the side;

FIG. 11 is a perspective view of an apparatus according to a second modification shown from the front;

FIG. 12 is a perspective view of a support plate of the apparatus according to the second modification shown from the bottom;

FIG. 13 is an enlarged block diagram of an engagement opening and a hook claw facing the engagement opening;

FIG. 14 is an enlarged block diagram of the hook claw, with a bent portion at the point of the hook claw being inserted into the engagement opening;

FIG. 15 is an enlarged block diagram depicting a state where the hook claw inserted in the engagement opening is prevented from coming off by an engagement member;

FIG. 16 is an enlarged block diagram depicting a state where the engagement member is pulled out from the engagement opening;

FIG. 17 is a timing chart for explaining a recording operation and an erasing operation in an apparatus according to a third modification;

FIG. 18A is a schematic of an apparatus according to a fourth modification shown from the front;

FIG. 18B is a functional block diagram of the apparatus according to the fourth modification shown from the side;

FIG. 19 is a timing chart for explaining the recording operation and the erasing operation in the apparatus according to the fourth modification;

FIG. 20 is a timing chart for explaining a recording operation and an erasing operation in an apparatus according to a fifth modification;

FIG. 21A is a schematic of an apparatus according to a sixth modification shown from the front;

FIG. 21B is a functional block diagram of the apparatus according to the sixth modification shown from the side;

FIG. 22 is a block diagram depicting a flow of information communication between the apparatus according to the sixth modification and a server;

FIG. 23 is a schematic of an apparatus according to a seventh modification shown from the front;

FIG. 24 is a perspective view of a support plate of an apparatus according to an eighth modification shown from the front;

FIG. 25 is an enlarged block diagram of a hook claw and an engagement opening in the support plate;

FIG. 26 is an image of an apparatus according to a ninth modification and an indoor office environment in which the apparatus according to the ninth modification is installed;

FIG. 27 is a block diagram of an apparatus according to a tenth modification shown from the side;

FIG. 28 is a block diagram of the apparatus according to the tenth modification, in a state where a reversible thermosensitive sheet is cut;

FIG. 29 is a block diagram of a weight in the apparatus according to the tenth modification;

FIG. 30 is a block diagram of a state where the reversible thermosensitive sheet is pulled out from a casing of the apparatus according to the tenth modification;

FIG. 31 is a block diagram of the apparatus according to the tenth modification in a state where a weight is being fitted to the end of the reversible thermosensitive sheet;

FIG. 32 is a block diagram of an apparatus according to an eleventh modification shown from the side;

FIG. 33 is a block diagram of the apparatus according to the eleventh modification, while a weight is being dropped;

FIG. 34 is a block diagram of the apparatus according to the eleventh modification in a state where winding of a sheet by a second rotating reel of the weight is started;

FIG. 35 is a perspective view of the apparatus according to the eleventh modification shown from the back;

FIG. 36 is an enlarged block diagram of a recording backup roller and a peripheral configuration thereof in an apparatus according to a twelfth modification;

FIG. 37 is an enlarged side view of a stop gear and a stop lever of the apparatus according to the twelfth modification;

FIG. 38A is a schematic of an image display apparatus according to a second embodiment of the present invention shown from the front;

FIG. 38B is a functional block diagram of the image display apparatus shown from the side; and

FIG. 39 is a perspective view of the image display apparatus shown from the back.

### DETAILED DESCRIPTION OF THE PREFERRED EMBODIMENTS

Exemplary embodiments of the present invention are explained in detail below with reference to the accompanying drawings.

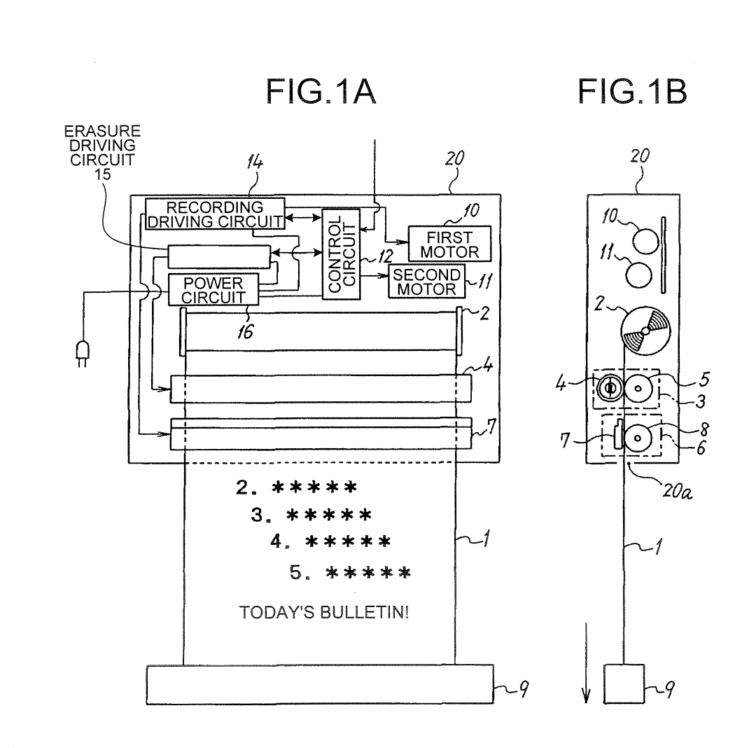

FIG. 1A is a schematic of the image display apparatus according to the first embodiment shown from the front. FIG. 1B is a functional block diagram of the image display apparatus shown from the side. The image display apparatus includes a reversible thermosensitive sheet 1, a rotating reel 2, an erasing unit 3, a recording unit 6, a weight 9, a first motor 10, a second motor 11, a control circuit 12, a recording driving circuit 14, an erasure driving circuit 15, a power circuit 16, and a casing 20.

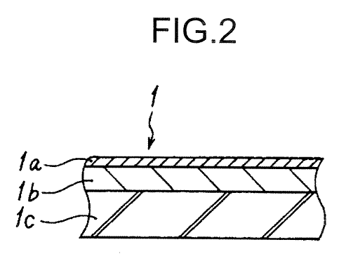

The rear side of the reversible thermosensitive sheet 1 as a sheet-like recording medium is wound around a core of a shaft of the rotating reel 2, and the front side thereof is fed from the core of the shaft of the rotating reel 2. As shown in FIG. 2, the reversible thermosensitive sheet 1 is a multilayer structure in which a base material layer 1c, a reversible recording layer 1b, and a protection layer 1a are sequentially laminated from the backside toward the surface side (the recording face side). The reversible thermosensitive sheet 1 has a well-known composition such that the sheet develops black color when being heated to a relatively high recording temperature (for example, 170 degrees) to form an image, and on the other hand, when being heated to a relatively low recording temperature (for example, 140 degrees), the sheet returns to white to erase the image.

In FIGS. 1A and 1B, the rotating reel 2 as a rotating unit is rotatably held by a bearing (not shown) at opposite ends of the core of the shaft, and a gear (not shown) is fixed to one end of the core of the shaft. The gear is connected to a motor shaft of the second motor 11 via a drive transmission mechanism (not shown) formed of a one-way clutch and a plurality of other gears. The one-way clutch is for transmitting a rotation driving force in a reverse direction transmitted from the second motor 11 to the rotating reel 2, and can idle the rotating reel 2 without transmitting the rotation driving force to the second motor 11, when the rotating reel 2 rotates in a normal rotation direction (the counterclockwise direction in FIG. 1B) by itself.

The erasing unit 3 arranged below the rotating reel 2 in FIG. 1B includes a heating roller 4 for erasure and an erasure backup roller 5, and forms an erasing nip by pressing the rollers to each other. The heating roller 4 for erasure includes a low-temperature heating element 4a such as a halogen lamp inside a metallic hollow roller. The erasure backup roller 5 is covered with an elastic surface layer formed of an elastic material such as rubber or resin. When the image is erased, the surface temperature (the heating temperature for erasure) by heat generation of the low-temperature heating element 4a of the heating roller 4 for erasure is controlled by ON/OFF control of a power source by the erasure driving circuit 15 to the low-temperature heating element 4a. The control circuit 12 described later issues a command to execute an erasure process to the erasing unit 3.

The recording unit 6 is arranged below the erasing unit 3 in FIG. 1B. The recording unit 6 includes a thermal head 7 and a recording backup roller 8 to form a recording nip by pressing the rollers to each other. The thermal head 7 can turn on/off heating in a unit of dot according to a well-known technique. The recording backup roller 8 is covered with an elastic surface layer formed of an elastic material such as rubber or resin. The recording driving circuit 14 controls ON/OFF of heating in the thermal head 7 in a unit of dot.

The erasure backup roller 5 and the recording backup roller 8 are respectively connected to the first motor 10 via the drive transmission mechanism (not shown), to rotate in the normal rotation direction (the counterclockwise direction in FIG. 1B) at an equal linear velocity due to the rotation and driving of the first motor 10. The drive transmission mechanism connected to the first motor 10 also includes a one-way clutch, which allows idling of the erasure backup roller 5 and the recording backup roller 8 in the reverse rotation direction (the clockwise direction in FIG. 1B).

The power circuit 16 receives supplying the power from outside, converts the voltage thereof as required, and supplies the power to the control circuit 12, the recording driving circuit 14, and the erasure driving circuit 15.

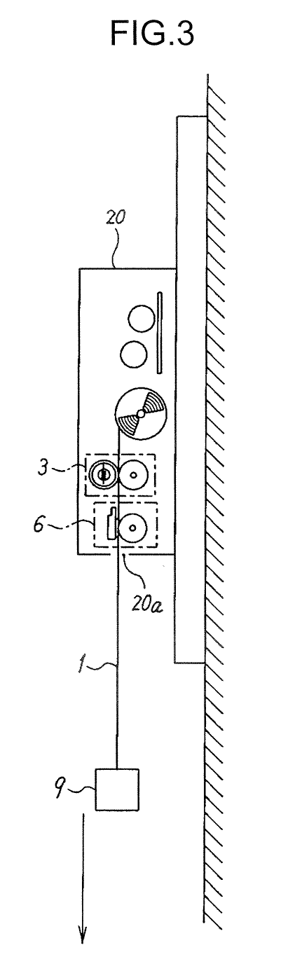

The casing 20 contains various members therein except of the weight 9. As shown in FIG. 3, the casing 20 is fixed to an inner wall via a support plate 30, which is a single-purpose support. An opening 20a extending in a direction orthogonal to the page is formed at the bottom of the casing 20.

The end of the reversible thermosensitive sheet 1 is a forwarding portion, which is not wound around the core of the shaft of the rotating reel 2, is sequentially inserted to the erasing nip of the erasing unit 3, the recording nip of the recording unit 6, and the opening 20a of the casing 20, and comes out to the outside of the casing 20. The weight 9 formed of metal or resin is fixed to the end of the reversible thermosensitive sheet 1 outside of the casing 20, and the forwarding portion of the reversible thermosensitive sheet 1 is suspended under the casing 20. In this state, a force to pull out the forwarding portion of the reversible thermosensitive sheet 1 from the casing 20 acts due to the weight of the weight 9. However, when the image display apparatus is in a suspended state, resistances of various gears of the backup roller, which put the forwarding portion therebetween, and the first motor 10 are stronger than the weight of the weight 9, thereby to prevent idling of the backup roller. Accordingly, the forwarding portion is prevented from being pulled out.

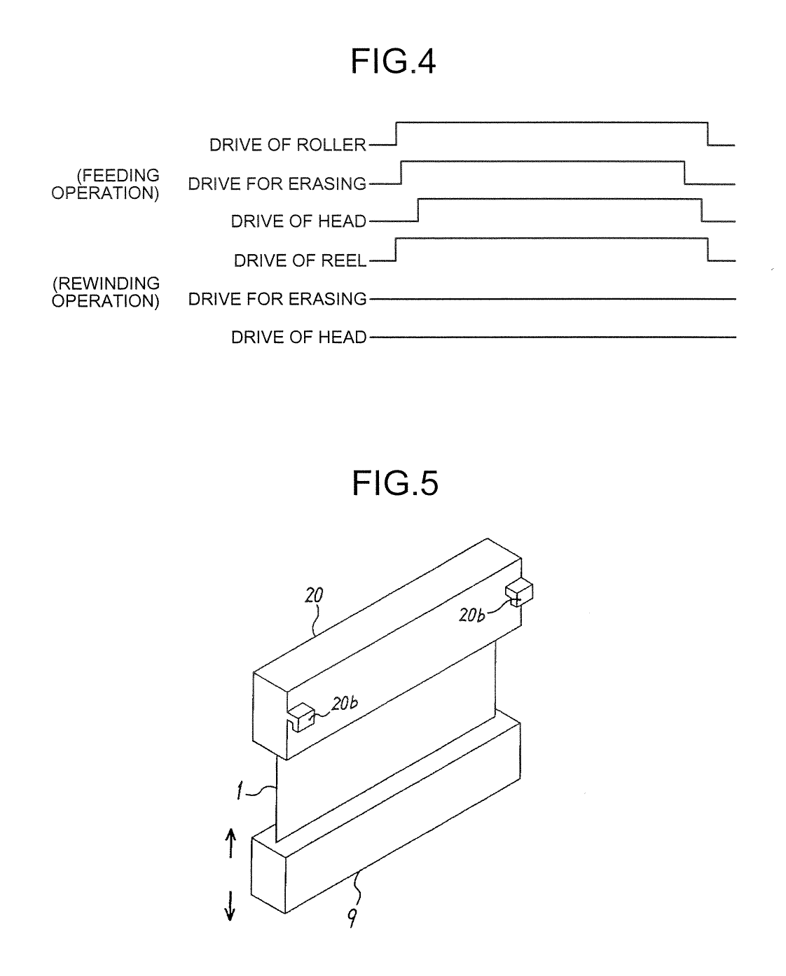

FIG. 4 is a timing chart for explaining a recording operation and an erasing operation of the image display apparatus. The reversible thermosensitive sheet 1 is wound around the rotating reel 2 in a state with an image being recorded. Upon reception of image information transmitted from an external personal computer or the like (not shown), the control circuit 12 transmits a drive start signal to the recording driving circuit 14 to start driving of the first motor 10. The erasure backup roller 5 and the recording backup roller 8 respectively start rotation at an equal linear velocity, to start to feed the reversible thermosensitive sheet 1 downward at the erasing nip and the recording nip (drive of roller in FIG. 4). The control circuit 12 transmits a drive start signal to the erasure driving circuit 15 to start generation of heat by the heating roller 4 for erasure (drive for erasure in FIG. 4).

Because the erasure backup roller 5 and the recording backup roller 8 rotate at the equal linear velocity, the forwarding portion of the reversible thermosensitive sheet 1 is further fed downward at the same velocity as the linear velocity. In the image display apparatus, therefore, the combination of the backup rollers, the drive transmission mechanism, the first motor 10, and the recording driving circuit 14 connected to the backup rollers functions as a shift-amount adjusting unit that adjusts a shift amount per unit time of the forwarding portion of the reversible thermosensitive sheet 1. Thus, because the shift of the forwarding portion is adjusted, the forwarding portion can be made to approach the recording nip sequentially at a constant velocity to record the image normally.

The recording driving circuit 14 controls ON/OFF of heating in the thermal head 7 in a unit of dot based on image information transmitted from the control circuit 12, while allowing the reversible thermosensitive sheet 1 to approach the recording nip at a constant velocity (drive of head in FIG. 4). Accordingly, an image is recorded on the reversible thermosensitive sheet 1 in the recording nip.

The forwarding portion on which the image has been recorded is sequentially fed downward with driving of the roller, and reaches the outside of the casing 20 through the opening 20a. Outside the casing 20, because the weight 9 is fixed to the end of the forwarding portion, the forwarding portion is pulled in a direction of gravity due to the load of the weight 9. Accordingly, the forwarding portion exposed outside from the opening 20a of the casing 20 is pulled straight in the direction of gravity, and functions as a screen for displaying the image.

Outside the casing 20, even when an extended amount of the forwarding portion from the opening 20a gradually increases with the progress of the recording operation, the forwarding portion is pulled straight and continues to function as the screen, until the weight 9 touches the floor. Accordingly, the large screen display can be achieved.

In this configuration, the reversible thermosensitive sheet 1 is stretched straight downward outside the casing 20 to function as the screen, without arranging the stretching unit that stretches the reversible thermosensitive sheet 1 by a plurality of stretching members. Accordingly, a portable small casing as shown in the figure can be used as the casing 20.

When recording of the image has finished, as shown in FIG. 4, drive for erasure, drive of head, and drive of roller are sequentially suspended, to stop extension of the reversible thermosensitive sheet 1 from the casing 20.

FIG. 5 is a perspective view of the image display apparatus shown from the back. In FIG. 5, a hook claw 20b as an engagement portion is respectively provided in a protruding state at opposite ends of the casing 20 in the lengthwise direction (the widthwise direction of the sheet) at the back.

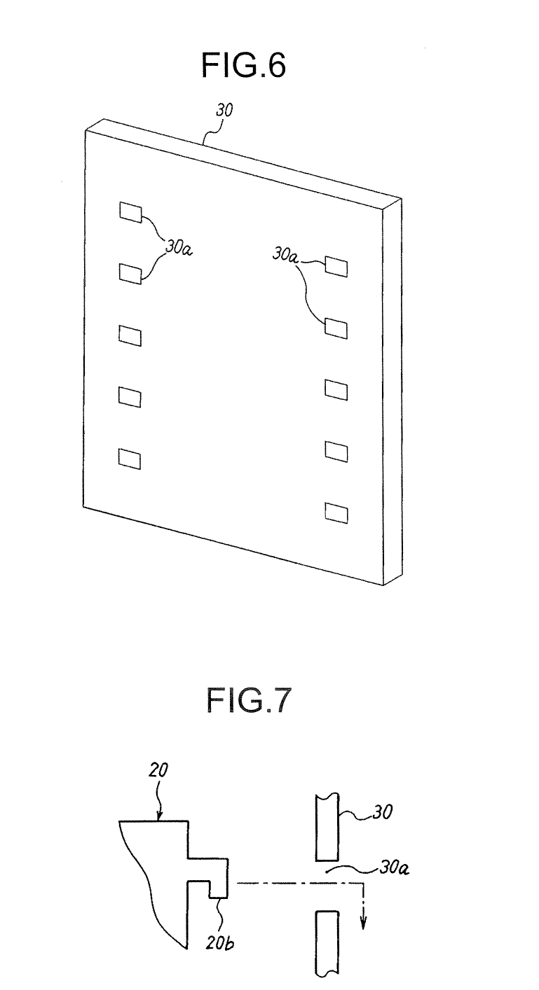

FIG. 6 is a perspective view of the support plate 30 as a support shown from the front. The support plate 30 is fixed to the wall of the room. An opening pair formed of two engagement openings 30a arranged in the widthwise direction of the sheet with a predetermined gap therebetween is arranged in a plurality of numbers along the lengthwise direction of the sheet, on the front face of the support plate 30.

When the casing 20 shown in FIG. 5 is set to the support plate 30 shown in FIG. 6, a following operation is performed. That is, the back of the casing 20 is overlapped on the front of the support plate 30, and the two hook claws 20b on the casing 20 are inserted into any one of the opening pairs arranged in multiple levels. As shown in FIG. 7, the hook claws are then hooked to the bottom wall of the engagement opening 30a. Accordingly, the hook claws 20b and the engagement openings 30a are engaged with each other, thereby fixing the casing 20 on the support plate 30.

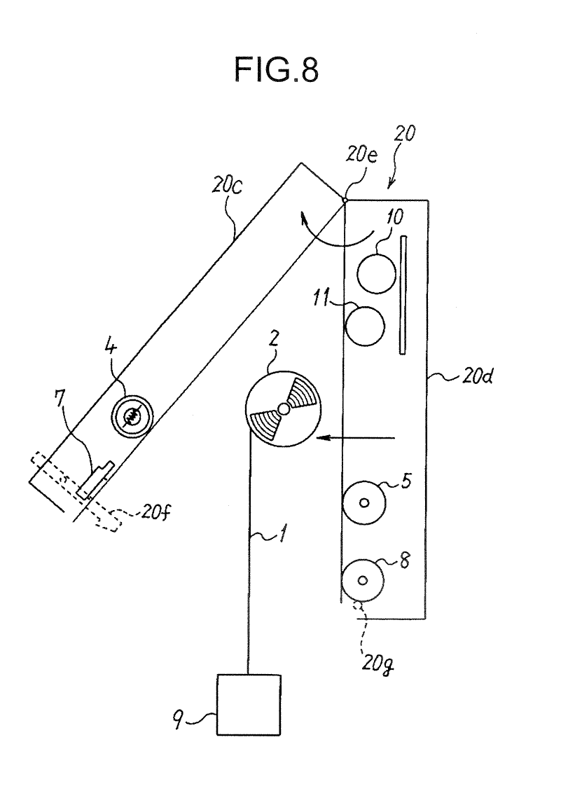

As shown in FIG. 8, the casing 20 can be separated into a front part 20c and a back part 20d. A rotation shaft 20e extending in the widthwise direction of the sheet is provided on the upper face of the casing 20. The front part 20c turns around the rotation shaft 20e, to be away from the back part 20d or join with the back part 20d. The front part 20c holds the heating roller 4 for erasure and the thermal head 7 as the recording unit, and when the front part 20c is opened, those portions are away from the back part 20d. On the other hand, the back part 20d holds two backup rollers 5 and 8, the rotating reel 2, the motors 10 and 11, and various circuit boards. When the front part 20c is opened, the rotating reel 2 in the back part 20d is exposed outside. The rotating reel 2 can be easily taken out by pulling out the rotating reel 2 as shown by arrow in FIG. 8 in this state. In this configuration, because the rotating reel 2 is detachable relative to the casing 20, recovery and replacement of the reversible thermosensitive sheet 1 can be easily performed.

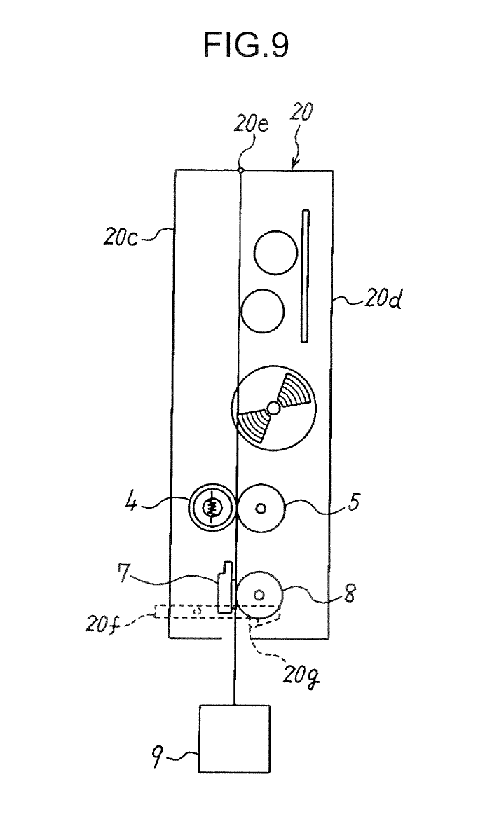

A swinging lever 20f is provided on the side of the front part 20c. A fixing pin 20g is provided in a protruding state on the side of the back part 20d. When the front part 20c is closed, the end of the swinging lever 20f is hooked on the fixing pin 20g on the back part 20d, as shown in FIG. 9. Accordingly, the front part 20c can be latched at a position where the two backup rollers 5 and 8 in the back part 20d can be pressed sufficiently against the back face of the reversible thermosensitive sheet 1.

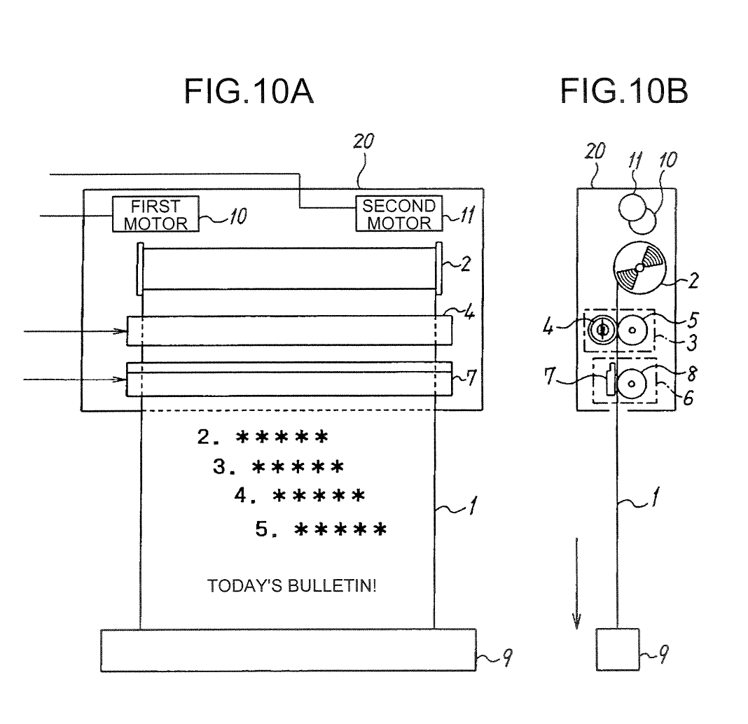

FIG. 10A is a schematic of an apparatus according to a first modification of the image display apparatus according to the first embodiment shown from the front. FIG. 10B is a functional block diagram of the apparatus according to the first modification shown from the side. In the apparatus according to the first modification, various circuit boards are separated from the casing 20, to control various motors, the heating roller 4 for erasure and the thermal head 7 from outside.

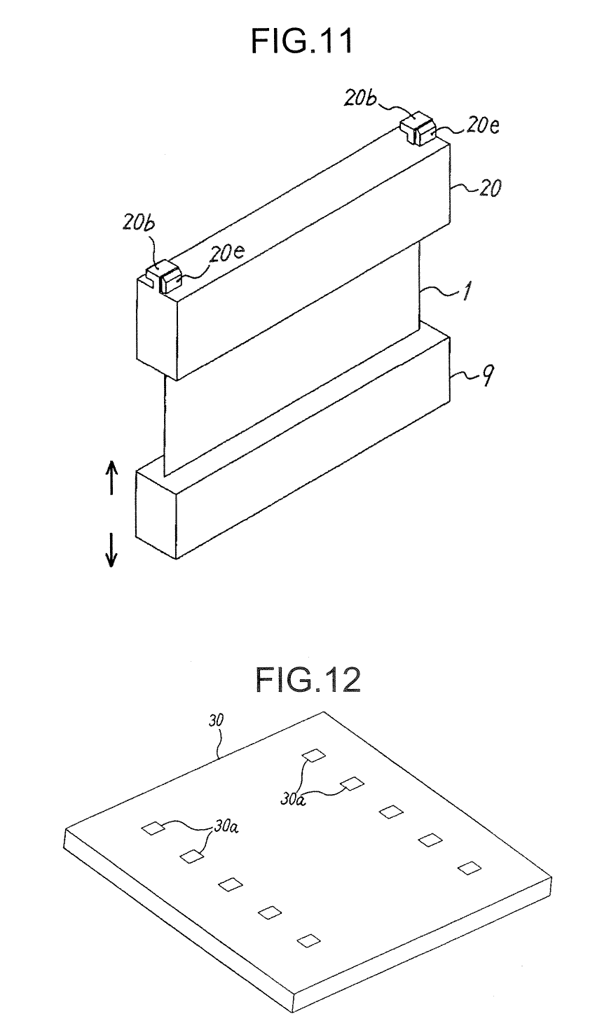

FIG. 11 is a perspective view of an apparatus according to a second modification of the image display apparatus according to the first embodiment shown from the front. In FIG. 11, the hook claw 20b as the engagement portion is respectively provided in a protruding state at opposite ends in the lengthwise direction on the upper face of the casing 20. An upper end of the hook claw 20b is bent toward the front of the casing 20.

A latching member 20e slidable in a vertical direction is set at the back of the hook claw 20b, to be housed in the casing 20 or to protrude from the upper face of the casing 20 due to the sliding movement thereof. However, because the latching member 20e is energized in a protruding direction by a spring (not shown), the latching member 20e normally protrudes from the upper face of the casing 20, as shown in FIG. 11, and is positioned right at the back of the hook claw 20b.

FIG. 12 is a perspective view of the support plate 30 as the support from the bottom. The support plate 30 is fixed to the ceiling of the room in a state of extending in a horizontal direction, with the bottom face directed downward in the vertical direction (a direction vertically opposite to the state shown in FIG. 12). An opening pair formed of two engagement openings 30a arranged in the widthwise direction of the sheet with a predetermined gap therebetween is arranged in a plurality of numbers along the horizontal direction.

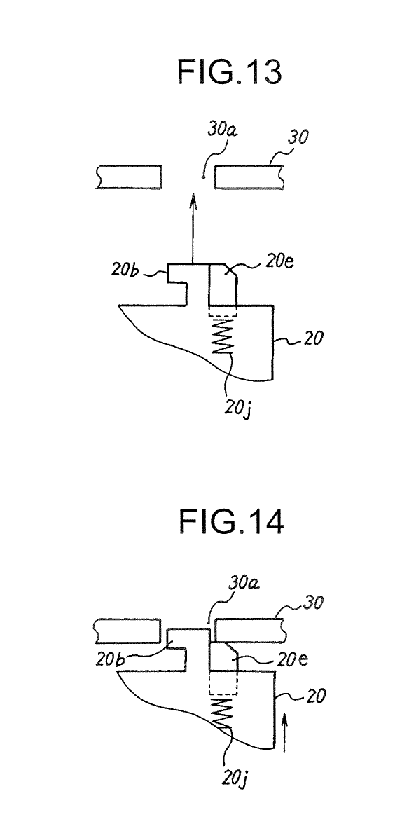

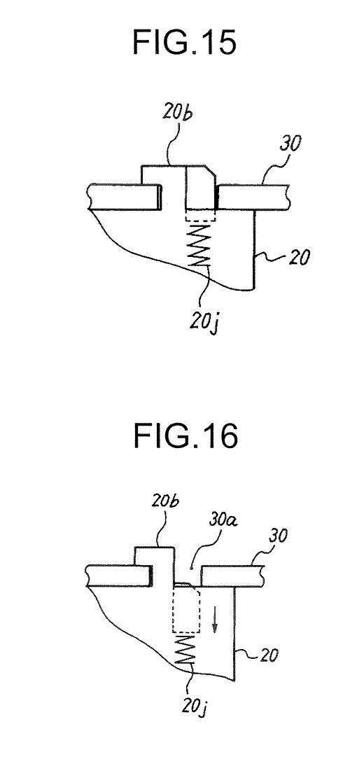

When the casing 20 shown in FIG. 11 is set to the support plate 30 shown in FIG. 12, a following operation is performed. That is, the upper face of the casing 20 is overlapped on the bottom face of the support plate 30, and the two hook claws 20b on the casing 20 are inserted into any one of the opening pairs arranged in multiple rows (FIG. 13). At this time, as shown in FIG. 14, because the opening size of the engagement opening 30a is only slightly larger than a horizontal size of the bent portion at the end of the hook claw 20b, the latching member 20e adjacent to the hook claw 20b does not enter the engagement opening 30a, and abuts against the support plate 30. In this state, if the casing 20 is pressed toward the ceiling, the latching member 20e is pressed into the casing 20, while the hook claw 20b is inserted into the engagement opening 30a. If the casing 20 is further pressed toward the ceiling, the bent portion at the end of the hook claw 20b passes through the engagement opening 30a, and a non-bent portion at the base of the hook claw 20b enters into the engagement opening 30a. In this state, because a large clearance is formed between the non-bent portion of the hook claw 20b and an inner wall of the engagement opening 30a, the casing 20 can be moved freely in the back and forth direction. When the casing 20 is moved forward, the latching member 20e housed in the casing 20 while abutting against the support plate 30 does not abut against the support plate 30 anymore, because the latching member 20e faces the clearance portion in the engagement opening 30a. Because the latching member 20e extends from the casing 20 due to an energizing force of a spring 20j, the latching member 20e enters into the clearance, as shown in FIG. 15. In this state, because the clearance is hardly present in the engagement opening 30a, free movement of the casing in the back and forth directions is prevented. Accordingly, the casing 20 is prevented from falling due to coming out of the hook claw 20b from the engagement opening 30a.

On the other hand, when the casing 20 is detached from the support plate 30, a following operation is performed. That is, a handle (not shown) is provided in the latching member 20e, and an operator presses down the handle, to retract the latching member 20e into the casing 20. When the latching member 20e retracts into the casing 20 due to pressing of the handle, as shown in FIG. 16, a large clearance is formed in the engagement opening 30a, and the casing 20 can be moved freely in the back and forth direction. If the casing 20 is moved backward, the bent portion at the end of the hook claw 20b can pass the engagement opening 30a. In this state, by pulling the casing 20 downward, the casing 20 can be detached from the support plate 30.

An example has been explained in which the hook claw 20b is provided on the casing 20, and the engagement opening 30a is provided in the support plate 30. On the contrary, the hook claw can be provided on the support plate and the engagement opening can be provided in the casing. Further, the casing can be fixed by a general fixing method such as screwing, bonding, or fixing by tape.

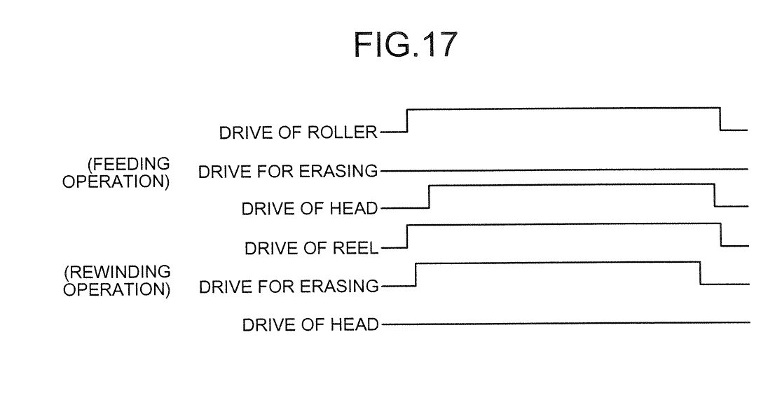

FIG. 17 is a timing chart for explaining a recording operation and an erasing operation in an apparatus according to a third modification of the image display apparatus according to the first embodiment. A mechanical configuration of the apparatus according to the third modification is the same as that of the first embodiment shown in FIGS. 1A and 1B. The apparatus according to the third modification is different from the image display apparatus in the first embodiment in the recording operation and the erasing operation.

As shown in FIG. 17, when the reversible thermosensitive sheet 1 is fed from the rotating reel 2, only the drive of the head is performed, among drive for erasure and drive of the head. In other words, the image is not erased. Erasure of the image (drive for erasure) is performed at the time of rewinding the forwarding portion of the reversible thermosensitive sheet 1 around the rotating reel 2.

In the above configuration, because recording and erasing of the image are performed at a completely different timing, a recording speed and an erasing speed can be set separately to an optimum value, respectively, thereby enabling excellent recording and erasing. Further, because the image is not left on the reversible thermosensitive sheet 1 wound around the rotating reel 2, information security can be increased. On the other hand, in the configuration in which the image is erased by the erasing unit 3 at the time of feeding the sheet from the reel, the image is left on the reversible thermosensitive sheet 1 wound around the rotating reel 2. Therefore, the image recorded last time can be redisplayed by feeding the wound reversible thermosensitive sheet 1 from the rotating reel 2, in the state with the thermal head being suspended.

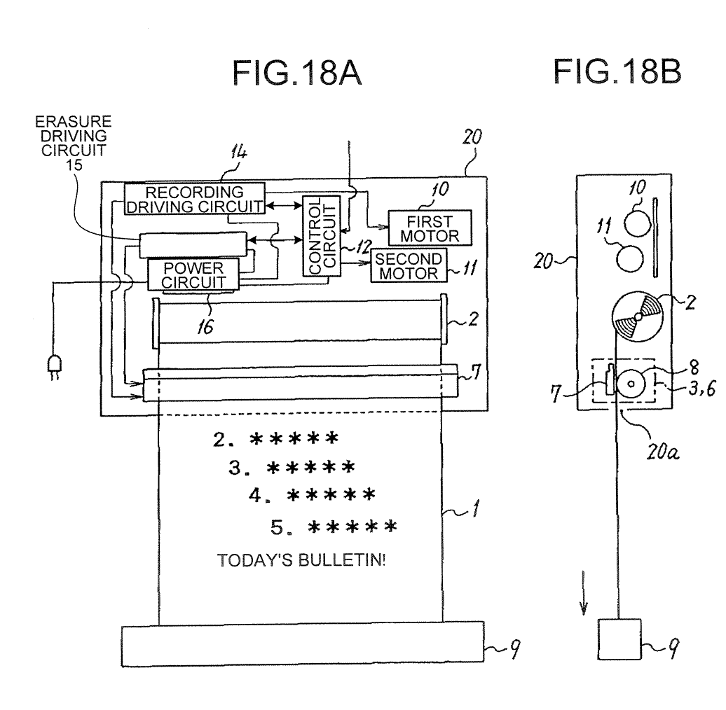

FIG. 18A is a schematic of an apparatus according to a fourth modification of the image display apparatus according to the first embodiment shown from the front, and FIG. 18B is a functional block diagram of the apparatus according to the fourth modification shown from the side. In this apparatus according to the fourth modification, the erasing unit 3 and the recording unit 6 are integral, and the heating roller for erasure and the backup roller for erasure dedicated to erasure are not provided. The mechanical configuration is approximately the same as that of the recording unit in the image display apparatus according to the first embodiment, and the image display apparatus includes the thermal head 7 and the recording backup roller 8.

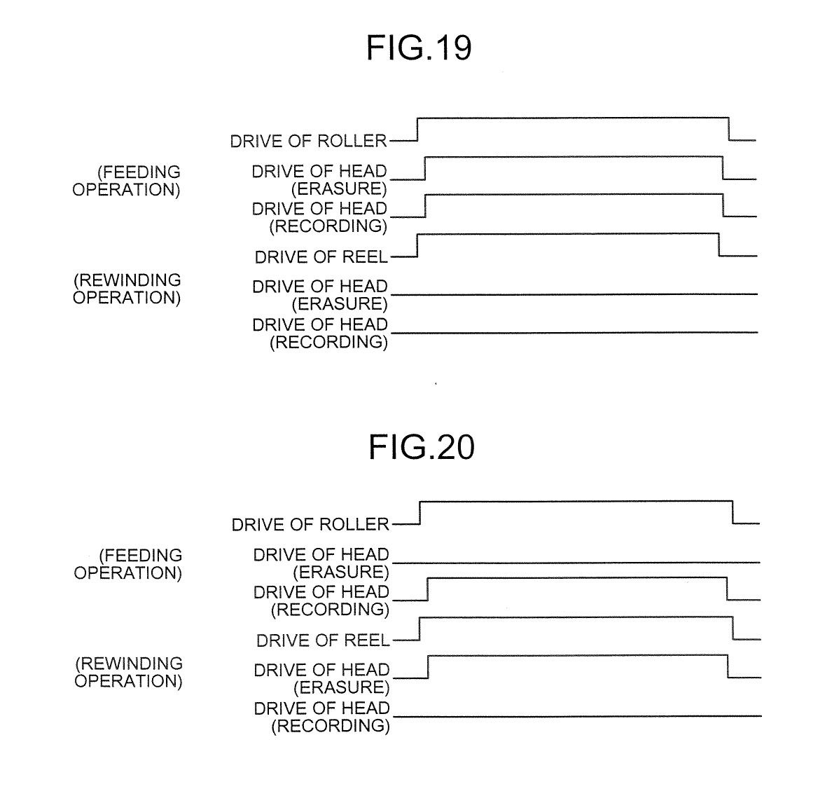

The recording driving circuit 14 and the erasure driving circuit 15 are connected to the thermal head 7. The thermal head 7 performs an erasure process relative to the image on the reversible thermosensitive sheet 1 at a position on an upstream side of the position for performing a recording process in the medium moving direction. That is, in the apparatus according to the third modification, the recording process is performed while performing the erasure process relative to the reversible thermosensitive sheet 1, as shown in the timing chart shown in FIG. 19. Also in this configuration, as in the image display apparatus according to the first embodiment, because the image is left on the reversible thermosensitive sheet 1 wound around the rotating reel 2, the image recorded last time can be redisplayed by feeding the wound reversible thermosensitive sheet 1 from the rotating reel 2, in the state with the thermal head being suspended.

FIG. 20 is a timing chart for explaining a recording operation and an erasing operation in an apparatus according to a fifth modification, which is another modified example of the apparatus according to the fourth modification. The mechanical configuration of the apparatus according to the fifth modification is the same as that of the apparatus according to the fourth modification shown in FIGS. 18A and 18B. Only the recording operation and the erasing operation are different from those of the apparatus according to the fourth modification.

As shown in FIG. 20, when the reversible thermosensitive sheet 1 is fed from the rotating reel 2, only the head for recording is driven, and the head for erasure is not driven. That is, the image is not erased. Erasure of the image is performed at the time of rewinding the forwarding portion of the reversible thermosensitive sheet 1 around the rotating reel 2.

Also in this configuration, like in the apparatus according to the third modification, a recording speed and an erasing speed can be set separately to an optimum value, respectively, thereby enabling excellent recording and erasing. Further, because the image is not left on the reversible thermosensitive sheet 1 wound around the rotating reel 2, information security can be increased.

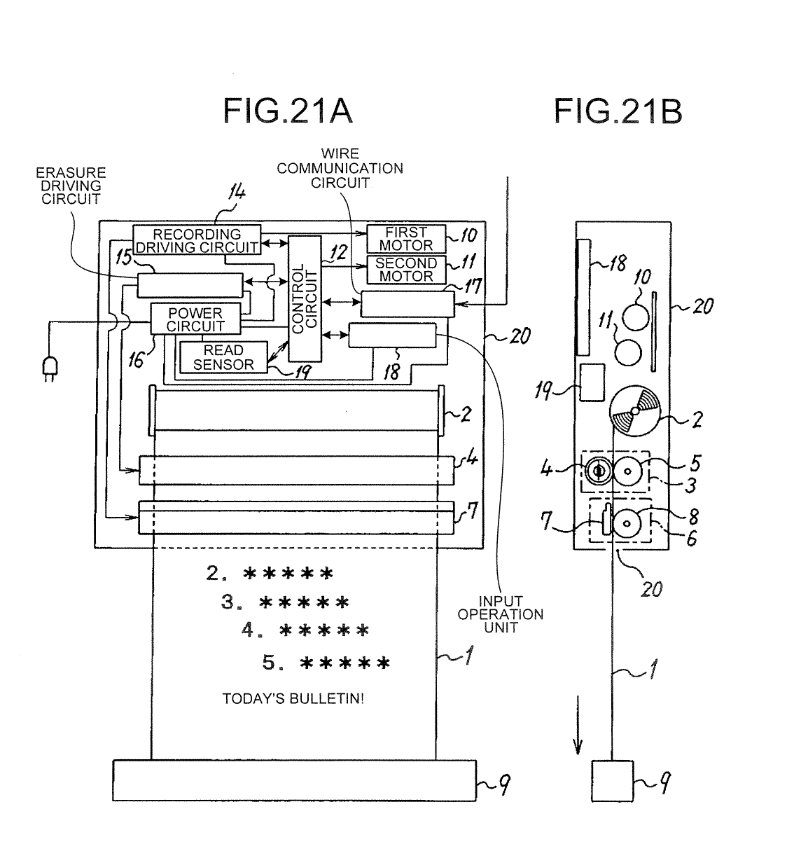

FIG. 21A is a schematic of an apparatus according to a sixth modification of the image display apparatus according to the first embodiment shown from the front, and FIG. 21B is a functional block diagram of the apparatus according to the sixth modification shown from the side. The apparatus according to the sixth modification has a wire communication circuit 17, an input operation unit 18, and a read sensor 19 in the casing 20.

The wire communication circuit 17 can perform information communication with an external computer server (not shown, hereinafter simply “server”). An information signal transmitted from the server is received by the wire communication circuit 17 and then transmitted to the control circuit 12.

The input operation unit 18 includes a ten key (not shown) and a plurality of buttons such as single-purpose keys, and transmits a signal corresponding to the pressed button. The input operation unit 18 includes a display-content selection key group as the single-purpose keys, which is formed of, for example, plural kinds of display-content selection keys, such as “e-mail”, “notice from the administration department”, and “announcement”. The operator can input which information is to be displayed by selecting and pressing any one of these display-content selection keys.

The input operation unit 18 also includes a display-content communication timing-setting key group as the single-purpose keys, which is formed of, for example, plural kinds of communication timing-setting keys such as “10 minutes”, “30 minutes”, and “one hour”. The operator can update the information content displayed on the apparatus according to the sixth modification automatically at a predetermined timing, by selecting and pressing any one of these communication timing-setting keys.

Therefore, the input operation unit 18 functions as a selection-information receiving unit that receives the display-content selection information input from outside and an update-timing-information receiving unit that receives the display-content update timing information input from outside.

The read sensor 19 reads a human fingerprint according to a well-known technique, and outputs a read signal to the control circuit 12. In some offices, the information displayed on the image display apparatus can include personal information, information to be shown only to a particular person, or trade secret information. If these pieces of information are displayed at random, the information can be leaked to a person who has no confidentiality obligation. In the apparatus according to the sixth modification, therefore, the read sensor 19 as an identification-information receiving unit that reads fingerprint information as personal identification information is provided.

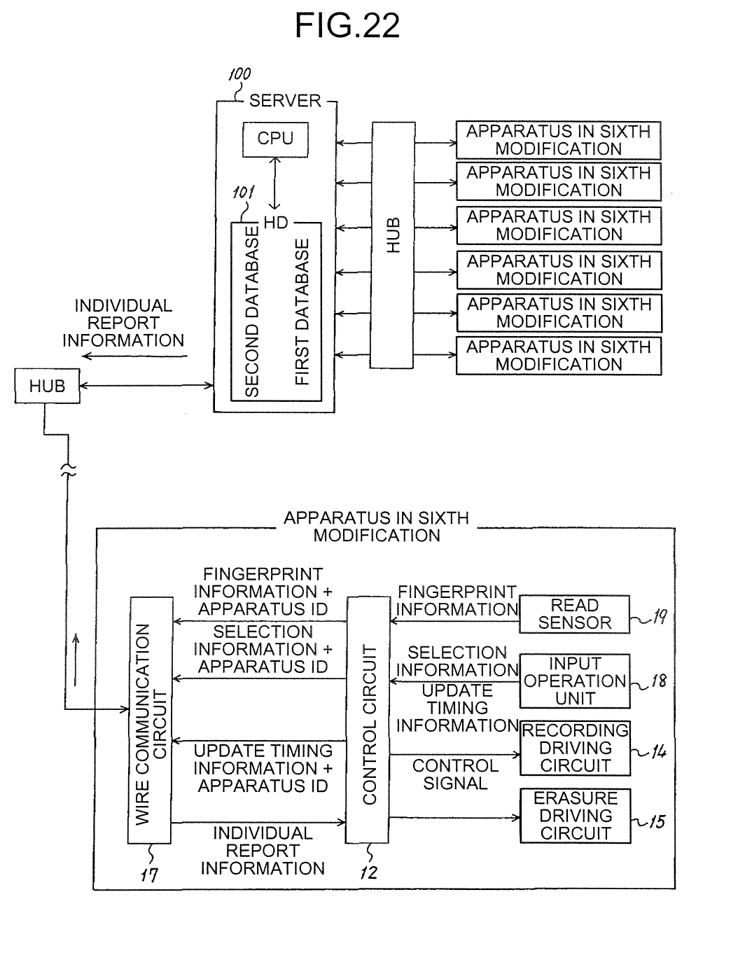

FIG. 22 is a block diagram depicting the flow of information communication between the apparatus according to the sixth modification and the server. A plurality of apparatuses according to the sixth modification are connected to the server, and an apparatus ID specific to the apparatus is respectively added to each of the apparatuses according to the sixth modification. The control circuit 12 in the apparatus according to the sixth modification stores the specific apparatus ID in a memory such as a read only memory (ROM).

The fingerprint information read by the read sensor 19 is transmitted to the control circuit 12. The control circuit 12 transmits the received fingerprint information together with the apparatus ID to a server 100 via the wire communication circuit 17.

When the operator presses any one key of the display-content selection key group, the input operation unit 18 outputs display-content selection information corresponding thereto to the control circuit 12. The display-content selection information is transmitted to the server, together with the apparatus ID, from the control circuit 12 via the wire communication circuit 17.

When the operator presses any one key of the display-content update timing information key group, the input operation unit 18 outputs display-content update timing information corresponding thereto to the control circuit 12. The display-content update timing information is transmitted to the server, together with the apparatus ID, from the control circuit 12 via the wire communication circuit 17.

The server 100 stores in a hard disk (HD) 101 a first database in which the fingerprint information of each person, personal ID corresponding thereto, and plural pieces of individual report information (“e-mail information”, “notice from the administration department”, and “announcement”), which is the information to be notified to the person corresponding to the personal ID are associated with each other. Further, the server 100 stores a second database in which the apparatus ID, apparatus operation information, operator information, the display-content selection information, and the display-content update timing information are associated with each other.

When a power switch (not shown) is turned on, the control circuit 12 in each of the apparatus according to the sixth modification outputs operation-ON information together with the apparatus ID to the server 100. The server 100 having received these pieces of information updates apparatus operation information corresponding to the apparatus ID in the second database from “out of service” to “in operation”.

When the power switch (not shown) is turned off (even if the power switch is turned off, the power is continuously supplied to the control circuit 12), the control circuit 12 in each of the apparatuses according to the sixth modification outputs operation-OFF information together with the apparatus ID to the server 100. The server 100 having received these pieces of information updates the apparatus operation information corresponding to the apparatus ID in the second database from “in operation” to “out of service”.

Upon reception of the fingerprint information and the apparatus ID from any one of apparatuses according to the sixth modification, the server 100 specifies the personal ID corresponding to the fingerprint information from the first database, and updates the operator information corresponding to the apparatus ID in the second database to a specified personal ID. Due to this update, it can be ascertained which apparatus according to the sixth modification is being used by which person.

Upon reception of the display-content selection information and the apparatus ID from any one of apparatuses according to the sixth modification, the server 100 updates the display-content selection information corresponding to the apparatus ID in the second database to a transmitted value.

Upon reception of the display-content update timing information and the apparatus ID from any one of apparatuses according to the sixth modification, the server 100 updates the display-content update timing information corresponding to the apparatus ID in the second database to a transmitted value.

Further, the server 100 regularly determines the necessity of transmission of information to each apparatus, based on the information in the second database. Specifically, the server 100 determines whether it is time to update the apparatus operation information in the second database, which is “in operation”, based on the display-content update timing information. When having determined to update the information, the server 100 specifies the display-content selection information and the operator information (personal ID) from the second database, extracts only the individual report information corresponding to the personal ID (and deletes the information from the second database), and transmits the information to the apparatus.

The apparatus having received the individual report information transmitted from the server 100 displays the information on the reversible thermosensitive sheet, while recording the information thereon as an image.

An example in which the fingerprint information is received as the personal identification information has been explained. However, other personal identification information can be used. For example, a personal ID recorded on a personal card can be received by a card reader. Alternatively, a radio frequency identification (RF-ID) tag held by a person can be read and received by an RF-ID reader, or a so-called brain-wave authentication can be adopted.

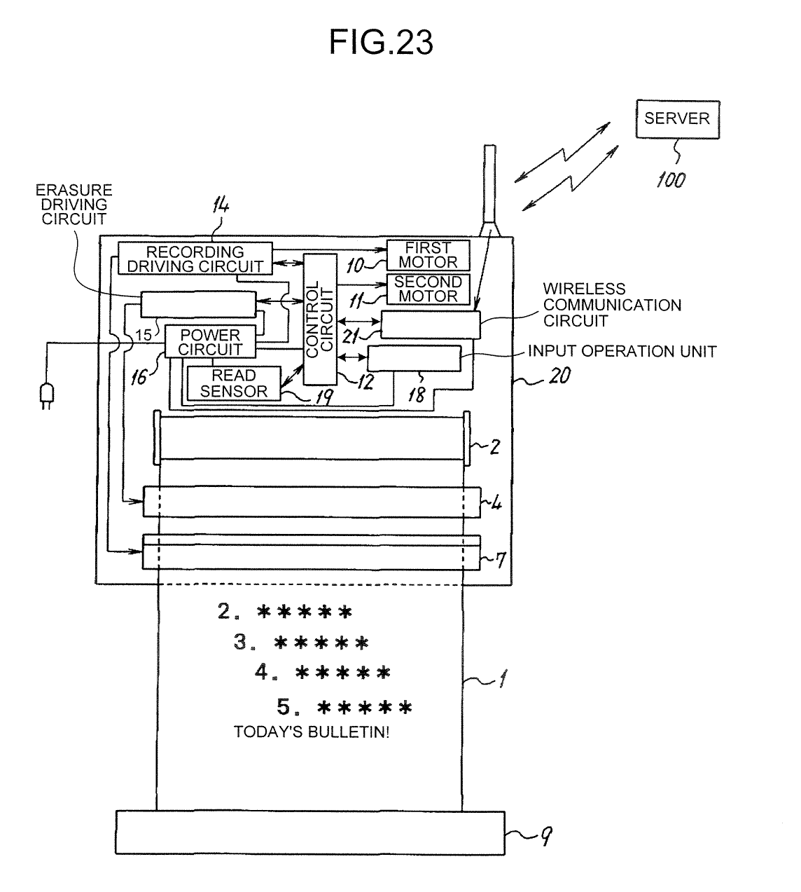

FIG. 23 is a schematic of an apparatus according to a seventh modification shown from the front, which is a modification of the apparatus according to the sixth modification. This apparatus is different from the apparatus according to the sixth modification in that it has a wireless communication circuit 21, instead of the wire communication circuit, to perform wireless communication with the server 100.

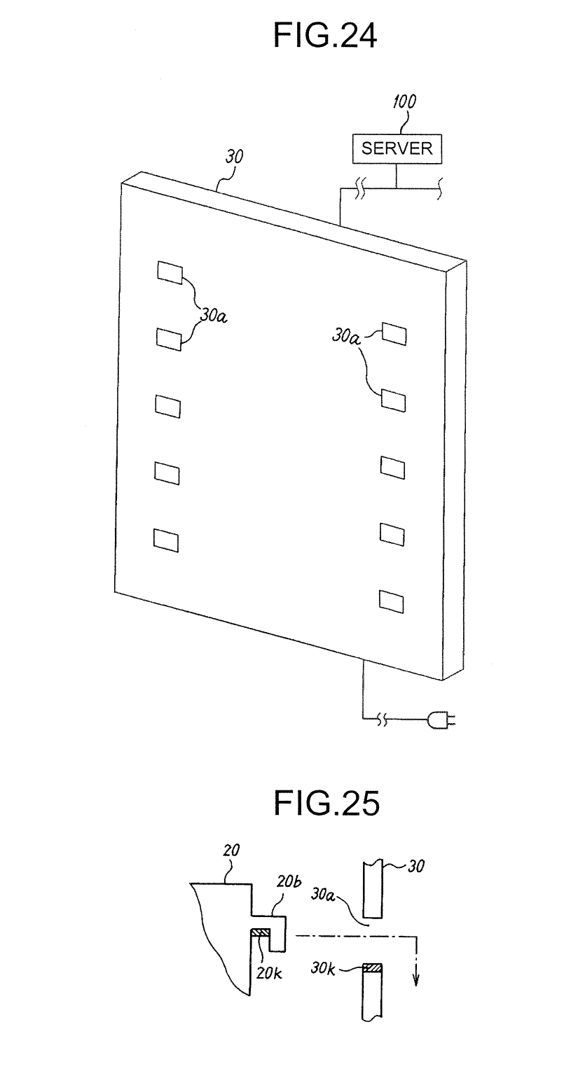

FIG. 24 is a perspective view of the support plate 30 of an apparatus according to an eighth modification, which is another modified example of the apparatus according to the sixth modification, shown from the front. This apparatus has the power circuit and the wire communication circuit in the support plate 30 instead of the casing. As shown in FIG. 25, a contact member 20k formed of a conductive material is fixed under the hook claw 20b provided at the back of the casing 20. In FIG. 25, although only one contact member 20k is shown, a plurality of contact members 20k are arranged in a direction orthogonal to the page relative to one hook claw 20b, with the insulated state being maintained with each other. On the other hand, a plurality of contact members 30k are arranged, with the insulated state being maintained with each other, on a lower wall of the engagement opening 30a in the support plate 30, which corresponds to one of the contact members 20k of the hook claw 20b.

The wire communication circuit (not shown) provided in the support plate 30 is connected to the contact member 30k provided on the lower wall of the engagement opening 30a. The power circuit (not shown) provided in the support plate 30 is also connected to the contact member 30k provided on the lower wall of the engagement opening 30a. On the other hand, the contact members 20k provided under the hook claw 20b of the casing 20 are connected to each circuit (not shown) in the casing 20.

When the casing 20 is fitted to the support plate 30, the hook claw 20b of the casing 20 engages with the engagement opening 30a in the support plate 30, so that the contact members 20k secured under the hook claw 20b and the contact members 30k arranged on the lower wall of the engagement opening 30a are pressed against each other to conduct with each other. Accordingly, the wire communication circuit and the power circuit (not shown) in the support plate 30 are connected to various circuits and elements (not shown) in the casing 20 via an electric wire and the contact members 30k and 20k.

In this configuration, because the wire communication circuit and the power circuit are not provided in the casing 20, the casing 20 (the image display apparatus) can be made small. Further, operability and portability can be improved, by making code connection to the casing 20 dispensable.

As shown in FIG. 24, the opening pairs formed of two engagement openings 30a arranged in the widthwise direction of the sheet are arranged in five levels in the vertical direction on the front of the support plate 30, and the contact members 30k are provided in each opening pair. The contact member for the power circuit is provided in the engagement opening 30a on the left in FIG. 24, and the contact member for the wire communication circuit is provided in the engagement opening 30a on the right in FIG. 24. A line pattern for connecting the contact members in each opening pair with the power circuit and the wire communication circuit is the same.

Further, although an example in which the wire communication circuit and the power circuit are provided in the support plate 30 has been explained, only either one of them can be provided therein. For example, even if only the power circuit is provided in the support plate 30, if the communication circuit to be arranged in the casing 20 is a wireless communication circuit, code connection to the casing 20 can be made dispensable.

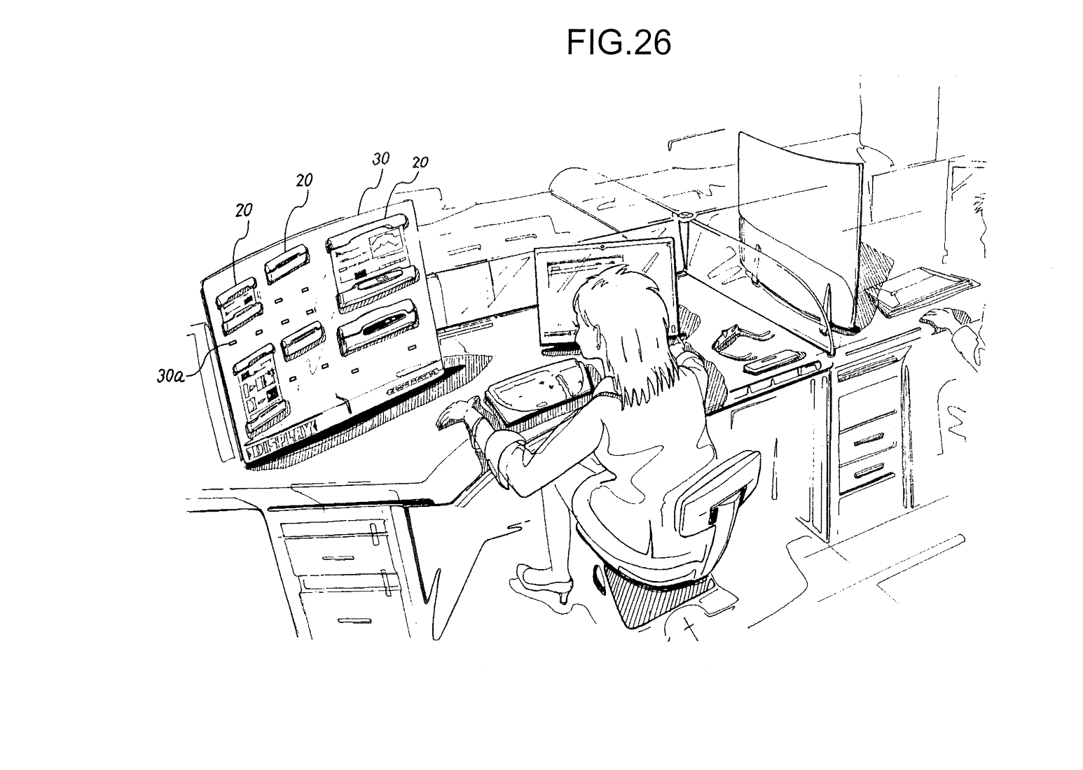

FIG. 26 is an image of an apparatus according to a ninth modification, which is another modified example of the apparatus according to the eighth modification, and an indoor office environment in which the apparatus according to the ninth modification is installed. In this apparatus, a standing type support plate is used as the support plate 30. Opening pairs formed of two engagement openings 30a arranged in the horizontal direction are provided not only in the vertical direction but also in the horizontal direction, on the front of the support plate 30. The contact members 30k are provided in each opening pair. However, wiring patterns for connecting the contact members in each opening pair with the wire communication circuit are different from each other, such that in a first opening pair, for example, a wiring pattern exclusive for the first opening pair is individually connected to the wire communication circuit.

When the casing 20 of the apparatus according to the ninth modification is set to the support plate 30, conduction is effected between any two contact members, among the contact members in the set opening pair. Due to the conduction, the wire communication circuit recognizes where the casing 20 has been set among the opening pairs in the support plate 30. Further, the wire communication circuit stores the relation between the opening pairs and the display-content selection information predetermined to correspond thereto individually. When information is transmitted from the server (not shown), the wire communication circuit specifies to which contact member in which opening pair the information is to be output, based on a selection classification ID added to the information. When the casing 20 has been set to the specified opening pair, the wire communication circuit outputs the transmitted information to the contact member. When the casing 20 has not been set to the specified opening pair, the wire communication circuit stores the transmitted information in a memory circuit, and at a point in time when the casing 20 is set to the opening pair, outputs the stored information to the contact member.

In the above configuration, as shown in FIG. 26, the operator can display information different from each other, by selecting to which opening pair in the support plate 30 the casing 20 is to be set, while using plural casings 20. Because the plural casings 20 are used, information of a different type from each other can be displayed simultaneously. For example, while general administration-related information is displayed by the casing 20 set to an opening pair in an area upper right in the depicted screen on the support plate 30, an e-mail can be displayed by the casing 20 set to an opening pair in a lower left area.

Furthermore, in the apparatus according to the ninth modification, as shown in FIG. 26, a desk space can be effectively used by installing the support plate 30 on a wall at the side of the desk. Regarding information to be displayed to a plurality of users, if the support plate 30 is provided in a common space instead of the desk space, the office space can be effectively used.

As previously explained with reference to FIG. 8, in the image display apparatus according to the first embodiment, the rotating reel 2 is easily detachable by opening the front part 20c of the casing 20 and pulling out the rotating reel 2 from the back part 20d. Accordingly, when the reversible thermosensitive sheet 1 deteriorates due to a scratch or the like, the reversible thermosensitive sheet 1 can be easily replaced by a new one.

However, if the entire reversible thermosensitive sheet 1 is not replaced, but only a locally deteriorated sheet portion is removed, the other portion can be effectively used, thereby enabling reduction of the running cost.

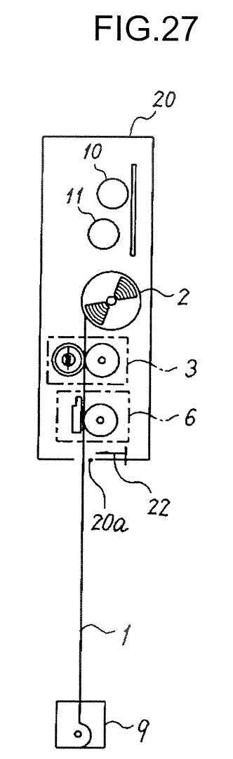

Therefore, in an apparatus according to a tenth modification of the image display apparatus according to the first embodiment, a configuration enabling such removal is added. FIG. 27 is a block diagram of the apparatus according to the tenth modification shown from the side. This apparatus has a moving cutter 22 on the right side in FIG. 27 of the opening 20a in the casing 20. In FIG. 27, a state where the moving cutter 22 is located at a home position is shown; however, the moving cutter 22 can reciprocate between the home position and a position right above the opening 20a. Note that, because the moving cutter 22 is normally energized by a spring (not shown) from the left toward the right in FIG. 27, the moving cutter 22 is at the home position.

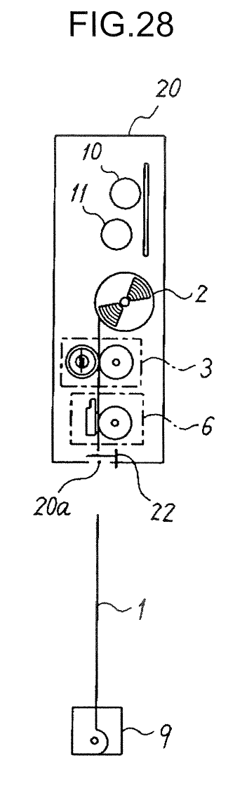

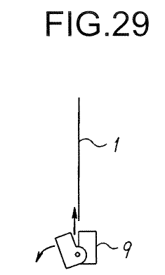

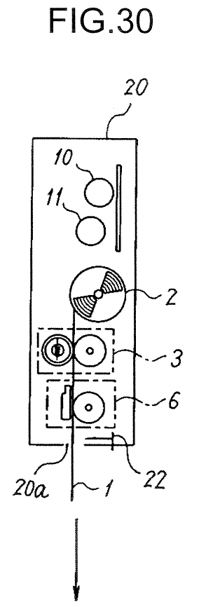

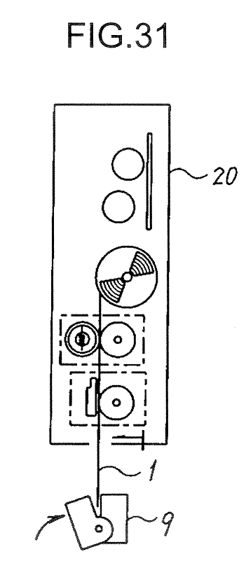

The operator manually pulls out the reversible thermosensitive sheet 1 or feeds the reversible thermosensitive sheet 1 by feed drive, to extend the reversible thermosensitive sheet 1 from the casing 20, thereby exposing the sheet portion to be removed to the outside. The operator slides the moving cutter 22 toward the left, while holding a handle provided on the moving cutter 22, and as shown in FIG. 28, cuts the reversible thermosensitive sheet 1 at a position of the opening 20a. The weight 9 is fixed to the end of the sheet obtained by cutting, which clamps the sheet end by a clamp mechanism. By releasing the clamp mechanism as shown in FIG. 29, the operator removes the weight 9 from the sheet end. As shown in FIG. 30, the operator then manually pulls out the reversible thermosensitive sheet 1 from the casing 20 to an appropriate length, or feed-drives the reversible thermosensitive sheet 1. As shown in FIG. 31, the operator fixes the weight 9 again to the sheet end.

Instead of providing the moving cutter 22, perforated lines can be provided in the reversible thermosensitive sheet 1 at a predetermined pitch, so that a part of the sheet can be removed by cutting the reversible thermosensitive sheet 1 at the perforated line.

In the image display apparatus according to the first embodiment, roughly a length from the floor in the room to the bottom of the casing 20 becomes the maximum height of the screen. If an image higher than this height is output, the weight 9 touches down on the floor, and the forwarding portion of the reversible thermosensitive sheet 1 becomes loose, and therefore the image cannot be displayed normally. In the apparatus according to the ninth modification shown in FIG. 26, roughly a length from the upper face of the desk to the bottom of the casing 20 becomes the maximum height of the screen. Accordingly, when display in a large amount is required, display needs to be performed by dividing the image into a plurality of pieces by repeating recording and erasing.

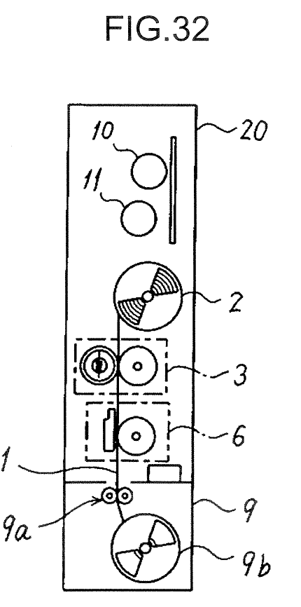

Therefore, in an apparatus according to an eleventh modification explained below, a configuration enabling continuous recording even for a display in a large amount is added. FIG. 32 is a block diagram of the apparatus according to the eleventh modification shown from the side. The apparatus is different from the image display apparatus according to the first embodiment in that the weight 9 is in a hollow box shape, and a reception roller pair 9a, a second rotating reel 9b, and a second driving unit (not shown) are provided therein. It is also different from the image display apparatus according to the first embodiment in that a distance sensor 23 formed of an ultrasonic sensor is provided in the casing 20. Although not apparent in FIG. 32, the configuration of the reversible thermosensitive sheet 1 is different from that of the image display apparatus according to the first embodiment.

The reversible thermosensitive sheet 1 fed from the casing 20 to the outside enters into the weight 9 through an opening provided on the upper face of the weight 9. The reversible thermosensitive sheet 1 then passes through a nip of the reception roller pair 9a, formed of two adjacent reception rollers, and is wound around the second rotating reel 9b. The second rotating reel 9b is rotated in the normal rotation direction, which is a counterclockwise direction in FIG. 32, by the second driving unit (not shown), to wind the reversible thermosensitive sheet 1 around itself. When the second rotating reel 9b is rotated in the reverse rotation direction, which is a clockwise direction in FIG. 32, the second rotating reel 9b feeds the reversible thermosensitive sheet 1 in an opposite direction to that of the rotating reel 2.

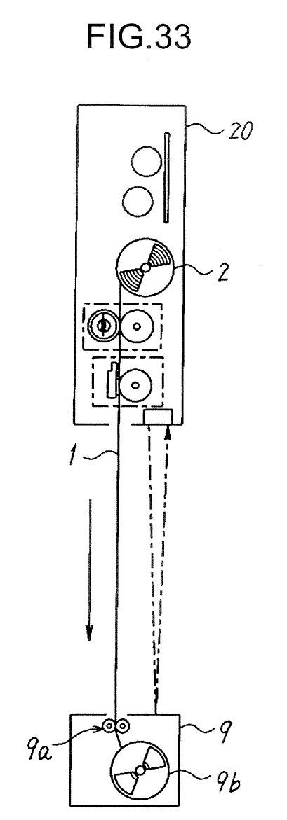

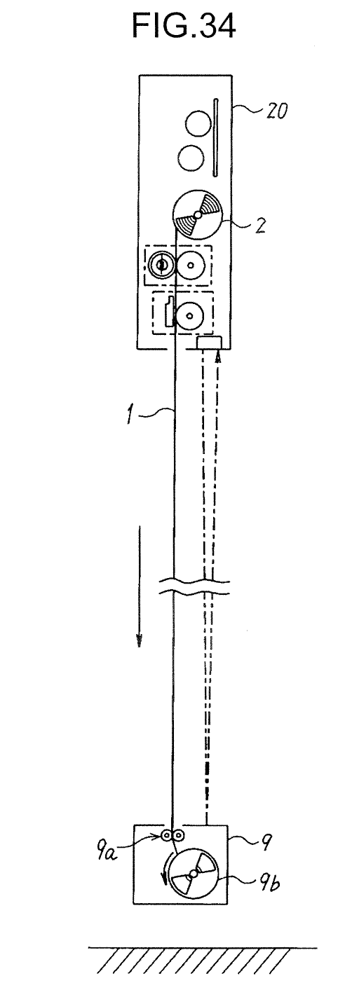

In the state shown in FIG. 32, the reversible thermosensitive sheet 1 is wound around the rotating reel 2 to a position where the weight 9 is brought into contact with the casing 20. When recording is started in this state, as shown in FIG. 33, the weight 9 gradually descends, with extension of the reversible thermosensitive sheet 1 from the casing 20. The distance sensor 23 fixed to the bottom of the casing 20 detects the distance from the weight 9, and sequentially outputs a detection result to the control circuit. While recording is continued, the weight 9 descends to near the floor, as shown in FIG. 34. When the distance between the distance sensor 23 and the weight 9 reaches a predetermined upper limit, the control circuit in the casing 20 supplies power to the second driving unit in the weight 9 via a flexible conductive foil. Accordingly, as shown in FIG. 34, the reversible thermosensitive sheet 1 starts to be wound around the second rotating reel 9b, thereby to stop descent of the weight 9. Even if the recording is continued, therefore, tension of the reversible thermosensitive sheet 1 can be maintained.

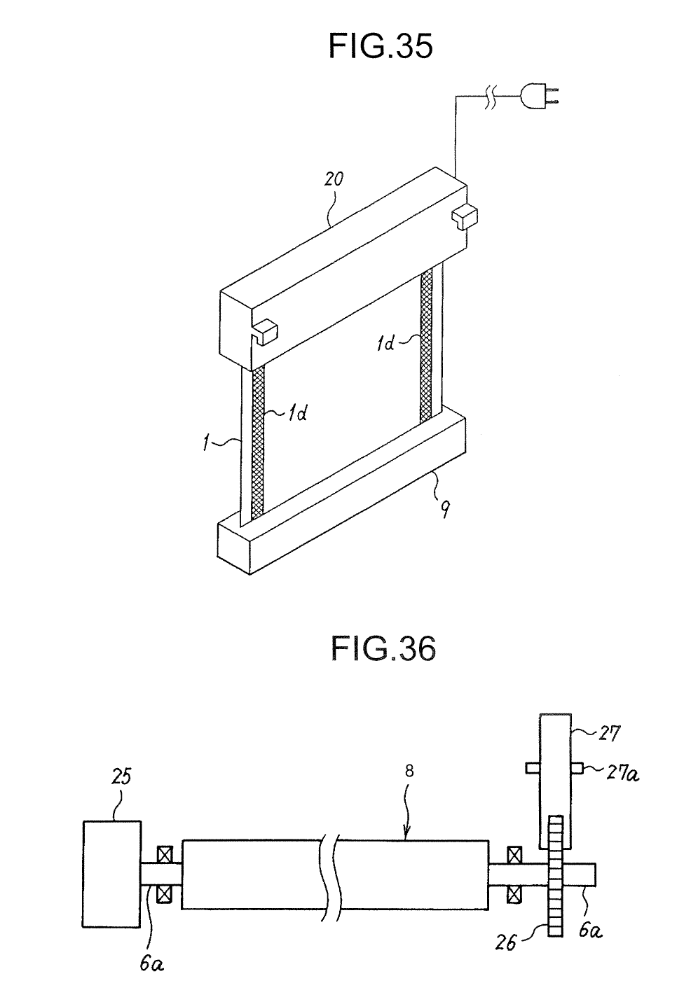

FIG. 35 is a perspective view of the apparatus according to the eleventh modification shown from the back. In FIG. 35, a plurality of flexible conductive foils 1d, which are conductive members that extend in the lengthwise direction, are arranged in a widthwise direction on the back (a face opposite to the recording face) of the reversible thermosensitive sheet 1 in the apparatus according to the eleventh modification. The flexible conductive foils 1d are formed all over the area in the lengthwise direction of the reversible thermosensitive sheet 1. The flexible conductive foils 1d, which looks like only one foil in FIG. 35, is actually an aggregate of a plurality of foils, and these are insulated from each other.

A plurality of contact members (not shown) are arranged in the casing 20, and respectively brought into contact with the flexible conductive foils 1d. These contact members are connected to the control circuit (not shown) in the casing 20. On the other hand, a plurality of contact members (not shown) are arranged in the weight 9 and respectively brought into contact with the flexible conductive foils 1d. These contact members are connected to the second driving unit (not shown) in the weight 9. The driving power output from the control circuit in the casing 20 toward the second driving unit is supplied to the second driving unit via the flexible conductive foils 1d. In this configuration, the power is supplied to the driving unit in the weight 9 without code connection to the weight 9 that moves vertically, thereby enabling improvement of handleability.

FIG. 36 is an enlarged block diagram of the recording backup roller 8 and a peripheral configuration thereof in an apparatus according to a twelfth modification of the image display apparatus according to the first embodiment. According to the twelfth modification, the apparatus does not include the driving unit formed of the first motor and the drive transmission mechanism for driving the erasure backup roller and the recording backup roller 8 shown in FIG. 36. Instead, the apparatus includes a speed regulator 25 and a stop lever 27 shown in FIG. 36. The weight of the weight is set heavier than that of the weight in the image display apparatus according to the first embodiment.

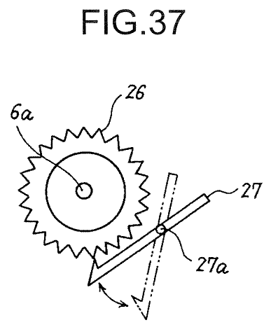

A stop gear 26 is fixed to a shaft on the right side in FIG. 36, of shafts respectively protruding from the opposite ends of the roller of the recording backup roller 8. A protrusion at the end of the stop lever 27 engages with the stop gear 26 as shown in FIG. 37. When the weight fixed to the end (not shown) of the reversible thermosensitive sheet 1 strongly pulls the sheet by the dead weight thereof, the reversible thermosensitive sheet tries to move downward. The recording backup roller 8 that presses the sheet by putting the sheet between the thermal head (not shown) and the backup roller tries to move by the rotation following the movement of the sheet. However, because the stop lever 27 engages with the stop gear 26, the rotation thereof is obstructed.

The stop lever 27 is supported rotatably, centering on a rotation shaft 27a. When a solenoid (not shown) is driven, the stop lever 27 is slightly rotated from a position shown by solid line to a position shown by dotted line in FIG. 37. The point of the stop lever 27 is then alienated from the gear of the stop gear 26. Due to the alienation, the recording backup roller 8 starts rotation, following the movement of the reversible thermosensitive sheet, and the reversible thermosensitive sheet starts to be fed from the rotating reel (not shown).

The speed regulator 25 is connected to the left shaft of the recording backup roller 8 in the axial direction in FIG. 36. The speed regulator 25 rotates the shaft at a low speed regardless of a torque of the shaft according to a well-known technique. Because the speed regulator 25 is connected to the shaft, the recording backup roller 8 rotates at a uniform velocity, regardless of the extended amount of the weight and the reversible thermosensitive sheet, to feed the reversible thermosensitive sheet. Accordingly, the reversible thermosensitive sheet is fed at a uniform velocity to the recording unit.

In the above configuration, a combination of the speed regulator 25, the stop gear 26, the stop lever 27, and the solenoid functions as a following amount-adjusting unit that adjusts a following amount of the recording backup roller 8, which is going to move, following the movement of the reversible thermosensitive sheet. The sheet can be fed to the recording unit at a uniform velocity only by the load of the weight and the sheet, without using drive by the driving unit. The following amount-adjusting unit formed of the speed regulator 25 and the like can be provided on the erasure backup roller.

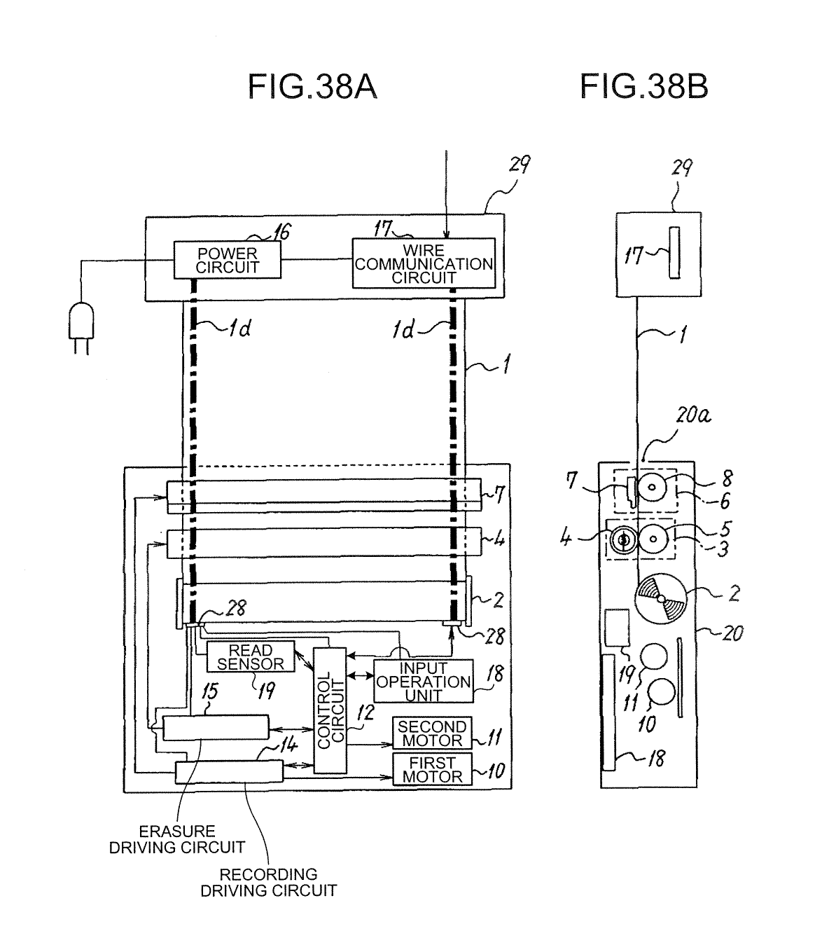

An image display apparatus according to a second embodiment of the present invention is explained next. The configuration of the image display apparatus according to the second embodiment is the same as that of the apparatus according to the sixth modification shown in FIGS. 21A and 21B, unless otherwise specified. FIG. 38A is a schematic of the image display apparatus according to the second embodiment shown from the front. FIG. 38B is a functional block diagram of the image display apparatus shown from the side. This image display apparatus is different from the apparatus according to the sixth modification in that a fixing member 29 for fixing the sheet to the support such as the support plate or the wall is fitted to the end of the reversible thermosensitive sheet 1 instead of the weight, and that the opening 20a in the casing 20 is used in a posture facing upward. The image display apparatus is also different from the apparatus according to the sixth modification in that the power circuit 16 and the wire communication circuit 17 are provided in the fixing member 29, not in the casing 20.

The casing 20 is positioned below the fixing member 29 and suspended from the fixing member 29 fixed to the wall or the like.

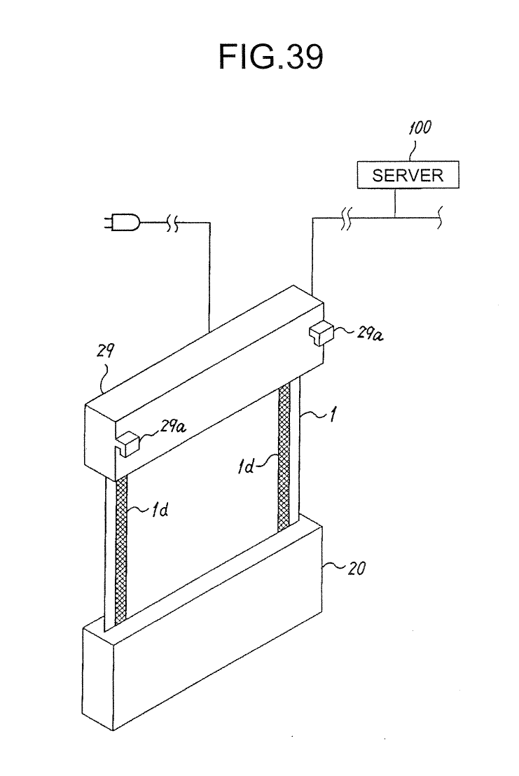

The power circuit 16 in the fixing member 29 and various types of equipment in the casing 20 are connected to each other via the flexible conductive foils provided at the back of the reversible thermosensitive sheet 1 as in the apparatus according to the eleventh modification. The wire communication circuit 17 in the fixing member 29 and the control circuit 12 in the casing 20 are connected to each other via the flexible conductive foils. The wire communication circuit 17 is connected to the server 100, as shown in FIG. 39.

A hook claw 29a that engages with the engagement opening in the support plate (not shown) is provided respectively to opposite ends in the lengthwise direction at the back of the fixing member 29.

In FIG. 38A, the recording driving circuit 14 controls ON/OFF of heating in the thermal head 7 in a unit of dot based on the image information transmitted from the control circuit 12, while allowing the reversible thermosensitive sheet 1 to approach the recording nip at a constant velocity. Accordingly, an image is recorded on the reversible thermosensitive sheet 1 in the recording nip.

The forwarding portion on which the image has been recorded is sequentially fed upward with the progress of the recording operation, and reaches the outside of the casing 20 through the opening 20a. Outside the casing 20, because the end of the forwarding portion is fixed to the fixing member 29 and the sheet is suspended from the fixing member, the forwarding portion is pulled in a direction of gravity due to the load of the casing 20 and various types of members contained in the casing 20. Accordingly, the forwarding portion exposed outside from the opening 20a of the casing 20 is pulled straight in the direction of gravity, and functions as a screen for displaying the image.

Outside the casing 20, even when the extended amount of the forwarding portion from the opening 20a gradually increases with the progress of the recording operation, the forwarding portion is pulled straight and continues to function as the screen, until the casing 20 touches the floor. Accordingly, the large screen display can be achieved.

Also in this configuration, the reversible thermosensitive sheet 1 is stretched straight outside the casing 20 to function as the screen, without arranging the stretching unit that stretches the reversible thermosensitive sheet 1 by a plurality of stretching members. Accordingly, a portable small casing as shown in FIG. 38B can be used as the casing 20.

The erasing operation of the image display apparatus is performed in a following manner. That is, upon reception of an erasure start instruction from the operator, for example, by pressing an erase button (not shown), the control circuit 12 drives the second motor 11 to start to reverse the rotating reel 2. Further, the control circuit 12 transmits a drive start instruction signal to the erasure driving circuit 15 to generate heat in the heating roller 4 for erasure. When the rotating reel 2 reverses (rotates in reverse), the forwarding portion of the reversible thermosensitive sheet 1 is wound around the rotating reel 2, and the casing 20 gradually moves upward. At this time, the erasure backup roller 5 and the recording backup roller 8 smoothly idle in the reverse rotation direction by a one-way clutch. The forwarding portion of the reversible thermosensitive sheet 1 extended outside of the casing 20 is then sequentially stored in the casing 20. The forwarding portion being stored is heated to a relatively low erasure temperature at the time of passing through the erasing nip to erase the image, before the forwarding portion is wound around the rotating reel 2.

An example in which the reversible thermosensitive sheet 1 is used as the sheet-like reversible thermosensitive recording medium has been explained. However, another recording medium can be used, so long as the recording medium is a sheet form. For example, a reversible thermosensitive recording medium in which white and black charging toners inserted between a pair of electrode substrates is electrostatically moved toward either one of the electrode substrates in the recording unit can be used, as described in Japanese Patent Application Laid-Open No. 2001-312225.

In the image display apparatus according to the second embodiment, the support plate 30, which is a support separated from the casing 20, is provided, the engagement opening 30a, which is a portion to be engaged, of the hook claw 20b and the engagement opening 30a engageable with each other, is provided on the support plate 30, and the hook claw 20b as the engagement portion is provided in the casing 20. In this configuration, the casing 20 can be easily fixed to a relatively high position to secure the screen area below the casing 20. Further, the screen area of the image display apparatus can be formed at a position of about user's eye level, even without securing an installation space on a desk.

In the image display apparatus according to the second embodiment, the engagement opening is provided on the support plate and the hook claw 29a is provided on the fixing member 29, of the hook claw 29a as the engagement portion and the engagement opening as the portion to be engaged, which are engageable with each other. In this configuration, the fixing member 29 can be easily fixed to a relatively high position to secure the screen area below the fixing member 29. Further, the screen area of the image display apparatus can be formed at a position of about the user's eye level, without securing the installation space on the desk.

In the respective embodiments and the apparatus according to the sixth modification, a controller formed of various circuits such as the control circuit 12, which controls the driving unit formed of the second motor 11, the drive transmission mechanism, and the like, the recording unit 6, and the erasing unit 3, is provided in the casing 20. In this configuration, the recording operation and the erasing operation can be performed without transmitting a control signal from outside to the casing 20.

In the image display apparatus according to the first embodiment and the apparatuses in the respective modifications, as the shift-amount adjusting unit, the one including the erasure backup roller 5 and the recording backup roller 8 as endlessly surface moving bodies, the surface-movement driving unit formed of the first motor 10, the drive transmission mechanism, and the like for endlessly moving the surfaces thereof, the swinging lever 20f as the pressing unit that presses the backup rollers against the reversible thermosensitive sheet 1, and the control circuit 12 as the drive controller that controls the surface-movement driving unit is used. In this configuration, the reversible thermosensitive sheet 1 can be fed at the constant velocity to the recording unit 6 by the drive of the backup roller, thereby to record the image normally.

In the image display apparatus according to the second embodiment, the recording backup roller 8 as the endless moving body held to enable endless movement of the surface, the swinging lever 20f as the pressing unit that presses the backup roller against the reversible thermosensitive sheet 1, and a following-amount adjusting unit formed of the speed regulator 25 that adjusts a following-amount of the recording backup roller 8, which tries to rotate, following the movement of the reversible thermosensitive sheet 1 are provided. In this configuration, the reversible thermosensitive sheet 1 is fed to the recording unit 6 at the constant velocity without using a driving force of the driving unit, thereby to record the image normally.

In the apparatuses in the third and fifth modifications, the controller is configured to control erasure of an image by the erasing unit 3, while rotating the rotating reel 2 in reverse as a rotating unit to rewind the reversible thermosensitive sheet 1. In this configuration, the recording speed and the erasing speed can be respectively set to an optimum value, thereby enabling excellent recording and erasing. Further, because the image is not left on the reversible thermosensitive sheet 1 wound around the rotating reel 2, information security can be increased.

In the image display apparatus according to the first embodiment and the apparatus according to the fourth modification, the controller is configured to control erasure of an image by the erasing unit 3, while normally rotating the rotating reel 2. In this configuration, because the image is left on the reversible thermosensitive sheet 1 wound around the rotating reel 2, the image recorded last time can be redisplayed by feeding the wound reversible thermosensitive sheet 1 from the rotating reel 2, in the state with the thermal head being suspended.

In the apparatus according to the sixth modification and the image display apparatus according to the second embodiment, because the power circuit 16 is provided in the casing 20 or the fixing member 29, power can be supplied to respective electrical equipment in the casing 20 or the fixing member 29.

In the apparatus according to the eighth modification, the power circuit is provided on the support plate 30, and the contact member functioning as an electric contact is respectively provided in the hook claw 20b and the engagement opening 30a, so that these contact members are brought into contact with each other, with an engagement between the hook claw 20b and the engagement opening 30a. In this configuration, because power can be supplied to the inside of the casing 20 when the casing is fitted to the support plate 30, connection of a power code to the casing 20 (or the fixing member) is not required, thereby improving the handleability.

In the apparatus according to the eleventh modification, the second rotating reel 9b as a second rotating unit that winds the forwarding portion of the reversible thermosensitive sheet 1 around the surface thereof with normal rotation or feeds back the forwarding portion with reverse rotation, while being held rotatably in both directions of normal and reverse rotations, and a second driving unit that drives the second rotating reel 9b at least in the direction of normal rotation are provided in the weight 9. In this configuration, continuous recording can be performed even for a display in a large amount exceeding a displayable area in a height direction. If the second rotating reel and the second driving unit are provided in the fixing member 29 in the image display apparatus according to the second embodiment, continuous recording can be performed as well for the display in a large amount.

In the apparatus according to the eleventh modification and the image display apparatus according to the second embodiment, a sheet having the flexible conductive foil, which is a conductive member arranged to extend along the lengthwise direction thereof is used as the reversible thermosensitive sheet 1, and the contact member that comes in contact with the conductive member is provided in the casing 20 and the weight 9 or the fixing member 29. In this configuration, power can be supplied or a control signal can be transmitted without connecting a power code or a control signal code to the weight 9 that vertically moves with the feed or rewinding of the sheet and the casing 20, thereby improving the handleability. Furthermore, such a trouble can be avoided that the power code or the control signal code is hooked by the weight 9 or the fixing member 29, accompanying the vertical movement of the weight 9 or the fixing member 29.

In the apparatus according to the sixth modification and the image display apparatus according to the second embodiment, because the wire communication circuit 17 for information communication is provided in the casing 20 or the fixing member 29, the casing 20 or the fixing member 29 can communicate information with the outside.

In the apparatus according to the eighth modification, the wire communication circuit, which is the communication unit for communicating information is provided on the support plate 30, and the contact member functioning as an electric contact is respectively provided on the hook claw 20b and the engagement opening 30a, so that these contact members are brought into contact with each other, with an engagement between the hook claw 20b and the engagement opening 30a. In this configuration, because a communication signal can be supplied to the casing 20 when the casing 20 is fitted to the support plate 30, the handleability can be improved.

In the apparatus according to the eighth modification, the controller formed of the control circuit 12 and the like can be provided on the support plate 30 instead of the casing 20, so that the controller and the casing 20 is connected via the contact member.

In the apparatus according to the ninth modification, a combination of the hook claw 20b and the engagement opening 30a is provided in a plurality of numbers, and each of the contact members 30k on the engagement opening is individually connected to the wire communication circuit 17. In this configuration, as shown in FIG. 26, various pieces of information different from each other can be displayed by selecting to which opening pair on the support plate 30 the casing 20 is to be set, while using a plurality of casings 20. Further, different various pieces of information can be simultaneously displayed by using a plurality of casings 20.

In the apparatus in the sixth, seventh, and eighth modifications, and the image display apparatus according to the second embodiment, the read sensor 19 is provided as the identification-information receiving unit that receives fingerprint information, which is personal identification information input from the outside. In this configuration, fingerprint authentication of the operator is performed, thereby enabling display of only the information suitable for the operator.

In the apparatus in the sixth, seventh, and eighth modifications, and the image display apparatus according to the second embodiment, the input operation unit 18 is provided as the selection-information receiving unit that receives the display-content selection information input from the outside. In this configuration, only the information of the content desired by the operator is selected and displayed.

In the apparatus in the sixth, seventh, and eighth modifications, and the image display apparatus according to the second embodiment, the input operation unit 18 is provided as the update-timing-information receiving unit that receives the display-content update timing information input from the outside. In this configuration, the display content can be regularly updated at a timing desired by the operator.

In all the apparatuses explained above, as the casing 20, the one capable of separating the front part 20c containing the thermal head as a recording processor in the recording unit 6 from the back part 20d containing the rotating reel 2 is used. Accordingly, the reversible thermosensitive sheet 1 can be easily replaced by separating the front part from the back part as required, thereby exposing the rotating reel 2.

As describe above, according to one aspect of the present invention, by fixing the casing to the wall or the ceiling with the forwarding portion of the recording medium exposed outside from the casing through the opening being suspended, the following becomes possible. That is, in this state, if the forwarding portion of the recording medium is fed to a recording position by the recording unit, while adjusting a shift amount per unit time of the forwarding portion of the recording medium fed from the rotating unit by a shift-amount adjusting unit, an image can be normally recorded on the forwarding portion. The forwarding portion, on which the image is recorded, reaches the outside of the casing via the opening with the progress of the recording operation. Outside the casing, because the weight is fixed to the end of the forwarding portion, the forwarding portion is pulled in the direction of gravity due to the load of the weight. Accordingly, the forwarding portion exposed outside from the opening of the casing is pulled straight in the direction of gravity, and functions as a screen for displaying the image. Even when the extended amount of the forwarding portion from the opening gradually increases with the progress of the recording operation, the forwarding portion is pulled straight and continues to function as the screen, until the weight touches the floor. Accordingly, the large screen display can be achieved. Because the recording medium is stretched straight to function as the screen, without using a stretching unit, and the screen is formed outside the casing, a portable small casing can be used as the casing. The image can be erased when an erasing unit is operated at a step of winding the recording medium. If the erasing unit is operated in the process of rewinding the recording medium, the image can be erased. When the erasing unit is provided on the upstream side of the recording unit in the medium moving direction, the image can be sequentially erased and recorded with feed of the recording medium. As a result, image display by using the recording medium is possible, and compatibility of portability and large screen display can be achieved.

Furthermore, according to another aspect of the present invention, by fixing the fixing member fitted to the end of the forwarding portion of the recording medium to the support such as the ceiling or the wall, and suspending the casing containing the rear end of the recording medium, the following becomes possible. That is, in this state, if the forwarding portion of the recording medium is fed to the recording position by the recording unit, while adjusting a shift amount per unit time of the forwarding portion of the recording medium fed from the rotating unit by the shift-amount adjusting unit, an image can be normally recorded on the forwarding portion. The forwarding portion, on which the image is recorded, reaches the outside of the casing via the opening with the progress of the recording operation. Outside the casing, because the end of the forwarding portion is fixed to the support and the casing is suspended below the support, the forwarding portion is pulled in the direction of gravity due to the load of the casing and various members contained therein. Accordingly, the forwarding portion exposed outside from the opening of the casing is stretched straight in the direction of gravity, and functions as a screen for displaying an image. Even when an extended amount of the forwarding portion from the opening gradually increases with the progress of the recording operation, the forwarding portion is stretched straight and continues to function as the screen, until the casing touches the floor. Accordingly, the large screen display can be realized. Because the recording medium is stretched straight to function as the screen, without using the stretching unit, a portable small casing can be used as the casing. The image can be erased like the above aspect. As a result, image display by using the recording medium is possible, and compatibility of portability and large screen display can be achieved.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image display apparatus comprising:
a recording medium on which an image can be recorded and erased repetitively;
a rotating unit that is supported in a rotating manner in both a normal direction and a reverse direction, and forwards the recording medium by rotating in the normal direction or rewinds the recording medium by rotating in the reverse direction;
a surface-movement driving unit that drives the rotating unit at least in the reverse direction;
a recording unit that records the image on a moving surface of the recording medium;
an erasing unit that erases the image recorded on the moving surface of the recording medium;
a casing that accommodates the rotating unit, the surface-movement driving unit, the recording unit, and the erasing unit;
a shift-amount adjusting unit that adjusts a shift amount per unit time of a forwarding portion of the recording medium in a forwarding direction at a recording position or on an upstream side of the recording position in the forwarding direction, being provided in the casing;
an opening for putting in and out the forwarding portion of the recording medium after recording the image, being provided in the casing; and
a weight that is fixed to the forwarding portion of the recording medium exposed outside from the opening.

2. The image display apparatus according to claim 1, further comprising a support that is provided as a separate body from the casing, including a portion to be engaged, wherein
the casing includes an engaging portion that is engageable with the portion to be engaged.

3. The image display apparatus according to claim 1, further comprising a control unit that controls the surface-movement driving unit, the recording unit, and the erasing unit, being provided in the casing.

4. The image display apparatus according to claim 1, wherein the shift-amount adjusting unit includes an endless moving body that endlessly moves, a driving unit for endlessly moving a surface of the endless moving body, a pressing unit that presses the endless moving body against the recording medium, and a drive control unit that controls the driving unit.

5. The image display apparatus according to claim 1, wherein the shift-amount adjusting unit includes an endless moving body that endlessly moves, a pressing unit that presses the endless moving body against the recording medium, and a following-amount adjusting unit that adjusts a following amount of the endless moving body following a movement of the recording medium.

6. The image display apparatus according to claim 3, wherein the control unit controls the erasing unit to erase the image while rotating the rotating unit in the reverse direction.

7. The image display apparatus according to claim 3, wherein the control unit controls the erasing unit to erase the image while rotating the rotating unit in the normal direction.

8. The image display apparatus according to claim 1, further comprising a power circuit for supplying a power to the image display apparatus, being provided in the casing.

9. The image display apparatus according to claim 2, further comprising:
a power circuit that provides a power to the image display apparatus, being provided on the support; and
a contact member functioning as an electric contact, being respectively provided in the engaging portion and the portion to be engaged, so that contact members are brought into contact with each other by an engagement of the engaging portion with the portion to be engaged.

10. The image display apparatus according to claim 1, further comprising:
a second rotating unit that winds the forwarding portion of the recording medium by rotating in the normal direction or feeds back the forwarding portion of the recording medium by rotating in the reverse direction; and
a second surface-movement driving unit that drives the second rotating unit at least in the normal direction, wherein
the second rotating unit and the second surface-movement driving unit are provided in the weight.

11. The image display apparatus according to claim 10, wherein
the recording medium includes a conductive member arranged to extend along a longitudinal direction of the recording medium, and
the image display apparatus further comprises a contact member that is brought into contact with the conductive member of the recording medium, being provided in the casing and the weight.

12. The image display apparatus according to claim 3, further comprising a communication unit for performing an information communication, being provided in the casing.

13. The image display apparatus according to claim 2, further comprising:
a communication unit for performing an information communication, being provided on the support; and
a contact member functioning as an electric contact, being respectively provided in the engaging portion and the portion to be engaged, so that contact members are brought into contact with each other by an engagement of the engaging portion with the portion to be engaged.

14. The image display apparatus according to claim 13, further comprising a control unit that controls the surface-movement driving unit, the recording unit, and the erasing unit, being provided on the support.

15. The image display apparatus according to claim 2, further comprising:
a communication unit for performing an information communication, being provided on the support;
a contact member functioning as an electric contact, being respectively provided in the engaging portion and the portion to be engaged, so that contact members are brought into contact with each other by an engagement of the engaging portion with the portion to be engaged; and
a control unit that controls the surface-movement driving unit, the recording unit, and the erasing unit, being provided on the support, wherein
a plurality of pairs of the engaging portion and the portion to be engaged are provided, and contact members of the portions to be engaged are individually connected to the communication unit or the control unit.

16. The image display apparatus according to claim 1, further comprising an identification-information receiving unit that receives personal identification information input from outside.

17. The image display apparatus according to claim 1, further comprising a selection-information receiving unit that receives display content selection information input from outside.

18. The image display apparatus according to claim 1, further comprising an update-timing-information receiving unit that receives display-content update timing information input from outside.

19. An image display apparatus comprising:
a recording medium on which an image can be recorded and erased repetitively;
a rotating unit that is supported in a rotating manner in both a normal direction and a reverse direction, and forwards the recording medium by rotating in the normal direction or rewinds the recording medium by rotating in the reverse direction;
a surface-movement driving unit that drives the rotating unit at least in the reverse direction;
a recording unit that records the image on a moving surface of the recording medium;
an erasing unit that erases the image recorded on the moving surface of the recording medium;
a casing that accommodates the rotating unit, the surface-movement driving unit, the recording unit, and the erasing unit;
a shift-amount adjusting unit that adjusts a shift amount per unit time of a forwarding portion of the recording medium in a forwarding direction at a recording position or on an upstream side of the recording position in the forwarding direction, being provided in the casing;
an opening for putting in and out the forwarding portion of the recording medium after recording the image, being provided in the casing; and
a fixing member for fixing the forwarding portion of the recording medium to a support that is a separate body from the casing, wherein
the fixing member is fitted to the forwarding portion of the recording medium exposed outside from the opening.

20. The image display apparatus according to claim 19, wherein
the support includes a portion to be engaged, and
the casing includes an engaging portion that is engageable with the portion to be engaged.
